(19) United States
(12) Patent Application Publication
(10) Pub. No.: US 2009/0215190 A1
(43) Pub. Date: Aug. 27, 2009

(54) APPARATUS AND METHOD FOR EXOTHERMIC AND ENDOTHERMIC REACTIONS

(76) Inventors: Pamela J. Stirn, Midland, MI (US); Charles A. Nielsen, Midland, MI (US); Sylvie Desjardins, Lake Jackson, TX (US); David R. Neithamer, Midland, MI (US); Paul L. Morabito, Midland, MI (US); Marc A. Springs, Angleton, TX (US)

Correspondence Address: The Dow Chemical Company, Intellectual Property Section, P.O. Box 1967, Midland, MI, 48641-1967, US

(21) Appl. No.: 12/389,820

(22) Filed: Feb. 20, 2009

Related U.S. Application Data
(60) Provisional application No. 61/031,400, filed on Feb. 26, 2008.

(51) Int. Cl. G01N 25/00

(52) U.S. Cl. 436/147; 422/82.12

(57) ABSTRACT

The present invention generally relates to an apparatus and method for running a plurality of essentially simultaneous exothermic reactions, endothermic reactions, or a combination thereof in sealed reactors and obtaining physico-chemical data, preferably temperature data, and, optionally, time data, for the reactions, wherein reaction mixtures in the sealed reactors are adiabatically thermally insulated from one another so that temperature in one sealed reactor does not materially affect temperature in any other, including an adjacent, sealed reactor.

### CROSS-REFERENCES TO RELATED APPLICATIONS

This application claims benefit of priority from U.S. Provisional Patent Application No. 61/031,400, filed Feb. 26, 2008, which provisional application is hereby incorporated by reference in its entirety.

The present invention generally relates to an apparatus and method for running a plurality of essentially simultaneous exothermic reactions, endothermic reactions, or a combination thereof in sealed reactors and obtaining physico-chemical data, preferably temperature data, and, optionally, time data, for the reactions, wherein reaction mixtures in the sealed reactors are adiabatically thermally insulated from one another so that temperature in one sealed reactor does not materially affect (as described later) temperature in any other, including an adjacent, sealed reactor.

### BACKGROUND OF THE INVENTION

Accurate monitoring of physico-chemical characteristics, such as temperature, of a plurality of stoichiometric or catalyzed exothermic or endothermic reactions is required to identify small differences in physico-chemical data profiles, e.g., temperature or temperature-time data profiles, among the reactions. For example, temperature or temperature-time data profiles of a plurality of reactions may provide information about temperature changes during reaction induction time periods (e.g., periods before maximum temperature is reached when a plot of temperature versus time data shows temperature asymptotically leaving a baseline starting temperature), time from reaction initiation to time at maximum temperature, maximum temperature reached, temperature changes during latent time periods (e.g., periods after maximum temperature is reached when plots of temperature versus time data show temperature asymptotically approaching a baseline ending temperature), time from maximum temperature to reach a baseline temperature, rates of temperature change, or, for endothermic reactions, minimum temperature reached, or a combination thereof. When variables of the plurality of exothermic reactions are experimentally varied, small differences in physico-chemical data profiles, e.g., temperature data or temperature-time data profiles, are produced that, if measured accurately (i.e., under adiabatic thermal insulating conditions), quickly provide important experimental information about the effects of changing the reaction variables on reaction efficiencies. Regarding catalyzed exothermic reactions, for example, improvements to catalyst efficiencies and substrate reactivities translate into increased manufacturing efficiencies, cost savings, and improved product characteristics.

Prior attempts to develop a multiple reactor apparatus for monitoring physico-chemical characteristics, such as temperature, of a plurality of essentially simultaneous reactions, however, produce elaborate devices that fail to accurately measure temperature due to a material loss of heat (as described below) from reaction mixtures, fail to detect subtle differences in temperature data or temperature-time data profiles due to thermal cross-talk between adjacent reactors, or a combination thereof. For example, U.S. Pat. No. 6,306,658 B1 illustrates in FIG. 9 and mentions in the text at column 13, line 19 to page 14, line 47, an apparatus and method for measuring calorimetric data. The apparatus comprises a reactor block that is made of a material having a high thermal conductivity such as aluminum, stainless steel, or brass. The reactor block holds vessels within wells formed in the reactor block. The wells may be lined with a thin layer of an insulating material to decrease heat transfer to or from the vessels or the insulating material may be eliminated from the apparatus. Maintaining a uniform thermal insulating condition throughout the reactor block requires active heating or cooling of the reactor block because the reactor block readily conducts heat away from reaction mixtures in the vessels.

Active heating or cooling of the reactor block uses the elaborate systems illustrated by FIGS. 6 to 8 and mentioned at column 10, line 19, to column 12, line 67 of U.S. Pat. No. 6,306,658 B1. Such systems include, among other things: separate heating elements for each vessel, a processor, a heater control system (FIG. 6); a liquid cooling and heating reactor block, a thermal fluid, a uniform temperature reservoir, a constant or variable speed pump, a heat pump, a heat transfer coil, a processor, a valve, and conduits (FIG. 7); or a reactor block, a heat transfer plate, a thermal fluid, a processor and a temperature monitor (FIG. 8).

There is a need for an apparatus and method for accurately measuring, and for detecting changes in, physico-chemical characteristics, preferably temperature, of a plurality of essentially simultaneous exothermic reactions, endothermic reactions, or a combination thereof, obtaining physico-chemical data, e.g., temperature data or temperature and time data, therefrom, and preferably using that physico-chemical data to evaluate and optimize variables that affect catalyst efficiency or yield, purity, or a functional characteristic of a product (as described below).

### SUMMARY OF THE INVENTION

In a first embodiment, the invention is an apparatus comprising: (a) a plurality of sealed reactors, each sealed reactor independently comprising one or more aperture seals and a reactor body, each reactor body having an exterior surface and an interior surface, the exterior surface being spaced apart from, and generally parallel to, the interior surface so as to define the reactor body, each reactor body defining one or more sealable apertures between the exterior surface and the interior surface of the reactor body, each sealable aperture being in sealing operative contact with at least one of the aperture seals, each sealed reactor having disposed therein an enclosed volumetric space that functions as a sealed reactor chamber, and each exterior surface of the reactor body independently having a thermally-insulating effective area, wherein for each sealable aperture in the reactor body, at least one of the aperture seals prevents fluid communication between the exterior surface of the reactor body and the sealed reactor chamber via the sealable aperture, the sealed reactor chamber of each sealed reactor is in fluid communication with at least a portion of the interior surface of the reactor body of the sealed reactor, and the sealed reactor chambers of the sealed reactors are not in fluid communication with one another and are spaced apart from each other; (b) one or more adiabatic thermal insulation means, wherein the thermally-insulating effective area of the exterior surface of each reactor body independently is in thermally-insulating operative contact with at least one of the one or more adiabatic thermal insulation means; (c) a plurality of physico-chemical sensors (preferably temperature sensors), wherein each physico-chemical sensor is in sensing communication with a different one of the sealed reactor chambers; and (d) at least one data device, wherein each data device is in data communication with one or more of the physico-chemical sensors and each physico-chemical sensor is in data communication with at least one data device. Preferably, there is one aperture seal for each sealable aperture. A variation of the first embodiment includes a means for establishing and maintaining sealed reactor spacing and orientation.

In a second embodiment, the invention is a method comprising the steps of: (a) adding at least a first reactant and a second reactant to each of at least two of the sealed reactor chambers of the apparatus according to the first embodiment so that the first and second reactants in each one of the at least two sealed reactor chambers are in operative contact with each other and comprise a reaction mixture that is sealed against fluid communication with a reaction mixture in any other of the at least two sealed reactor chambers and each one of the reaction mixtures is in sensing communication with a different one of the physico-chemical sensors, wherein the first reactants may be the same or different and the second reactants may be the same or different and (b) obtaining physico-chemical data, e.g., temperature data, for at least those reaction mixtures that form a reaction product. Preferably, at least one reaction mixtures forms a reaction product; but there may be instances where no reaction mixture forms a reaction product, e.g., during screening of a large number of reactants.

Additional embodiments are described in accompanying drawings and the remainder of the specification.

### BRIEF DESCRIPTION OF THE DRAWINGS

FIG. 1 is a schematic illustration of a partial section view of a 16-sealed reactor variation of an invention apparatus 5 of the first embodiment.

FIG. 2 is a schematic illustration of a base assembly 200 of the 16-sealed reactor variation of apparatus 5.

FIG. 3 is a schematic illustration of a chassis assembly 300 of the 16-sealed reactor variation of apparatus 5.

FIG. 3A is a schematic illustration of a partial exploded view of the chassis assembly 300 shown in FIG. 3.

FIG. 4 is a schematic illustration of a cover assembly 400 of the 16-sealed reactor variation.

FIG. 5 is a schematic illustration of an exterior view of the 16-sealed reactor variation of apparatus 5.

FIG. 6 is a graph plotting concentration of CAT-1, a Ziegler Natta titanium catalyst supported on magnesium chloride, versus maximum exotherm temperature reached using 50 mole equivalents of triethylaluminum (TEA) for the experiment of Example 2.

FIG. 7 is a graph plotting mole equivalents of triethylaluminum versus maximum exotherm temperature reached using 5 mMol of the CAT-1 Ziegler Natta catalyst for the experiment of Example 2.

### DETAILED DESCRIPTION OF THE INVENTION

The present invention is summarized above and further described below. The phrase “invention apparatus of the first embodiment” and “invention method of the second embodiment” are interchangeably referred to herein as “invention apparatus” and “invention method,” respectively. In describing the present invention, certain abbreviations, phrases, terms, and words are used that are defined herein. When interpreting a meaning of an abbreviation, phrase, term, or word, its definition herein governs unless, for a particular use, a different meaning is stated in this specification or unless a context of the use of the abbreviation, phrase, term, or word clearly indicates a different meaning is intended from the definitions provided herein.

### HIGHLIGHTED ABBREVIATIONS

° C.—degrees Celsius

cm—centimeters

L—liter(s)

mMol—millimole(s)

μmol—micromole(s)

mL—milliliter(s)

mM—millimolar (i.e., millimoles per liter)

mV—millivolts(s)

Articles “a” and “an” refer to singular and plural forms of what is being modified by the articles. The term “or” refers to members in a list either singly or in any combination.

The term “comprising,” which is synonymous with the terms “including,” “containing,” “having,” “group of,” and “characterized by,” is inclusive or open-ended. These terms do not exclude additional elements, materials, ingredients, or method steps, including unrecited ones, even if the additional elements, materials, ingredients, or method steps are present in major amounts. When the term “comprising” is used as a transition from a claim's preamble to the claim's body (i.e., as a transitional term), the entire claim is open-ended (although a specific element or step within the claim may be limited by a phrase such as “consisting of” or “consisting essentially of”).

The phrases “consisting of” or “group consisting of” are closed terms. These phrases exclude any element, step, or ingredient not specified. When the phrase “consisting of” is used as a transitional phrase in a claim, the phrase closes the claim to the inclusion of materials, elements, or steps that are not specifically recited in the claim except for impurities ordinarily associated therewith and materials, elements or steps that are unrelated to the claimed invention. When the phrase “consisting of” is used in a clause of the body of the claim rather than immediately following the preamble, it limits only the element, step, or material set forth in that clause and other elements, materials, or steps outside of the clause are not excluded from the claim. The present invention also includes embodiments written by modifying the “comprising” embodiments described elsewhere herein by replacing the transitional term “comprising” with the transitional phrase “consisting of.”

The phrase “consisting essentially of” may be used in a claim's preamble to limit the scope of the claim to the specified materials, elements, or steps and those that do not materially affect the basic and novel characteristic or characteristics of the claimed invention. Referring to preambles, a “consisting essentially of” claim occupies a middle ground between closed claims that are written in “consisting of” format and fully open claims that are drafted in a “comprising” format. The present invention also includes embodiments written by modifying the “comprising” embodiments described elsewhere herein by replacing the transitional term “comprising” with the transitional phrase “consisting essentially of.”

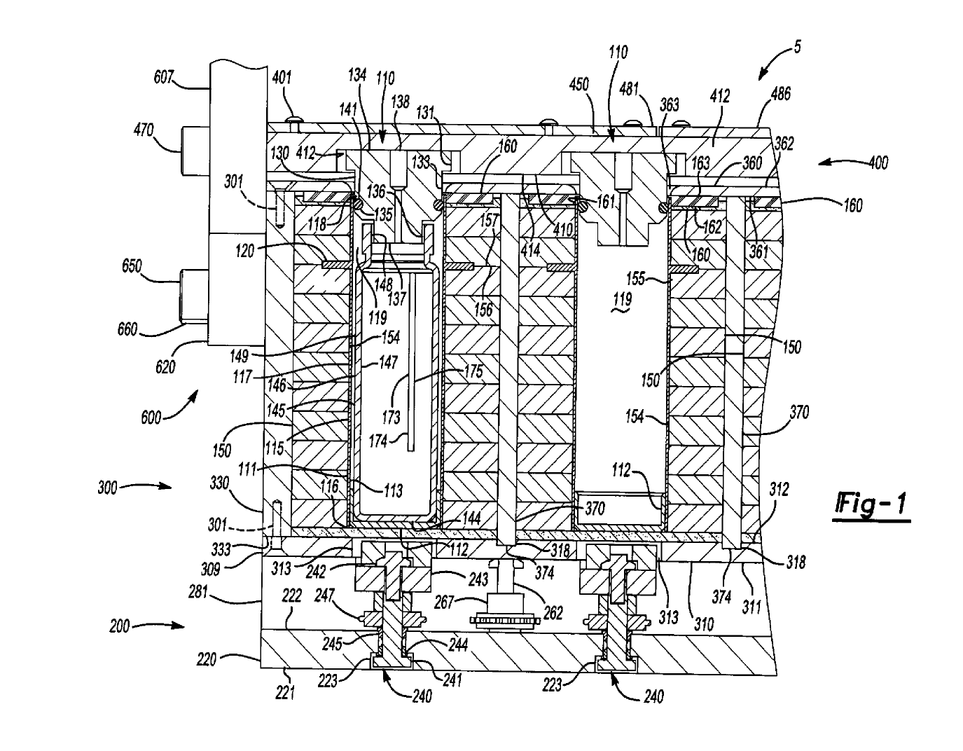

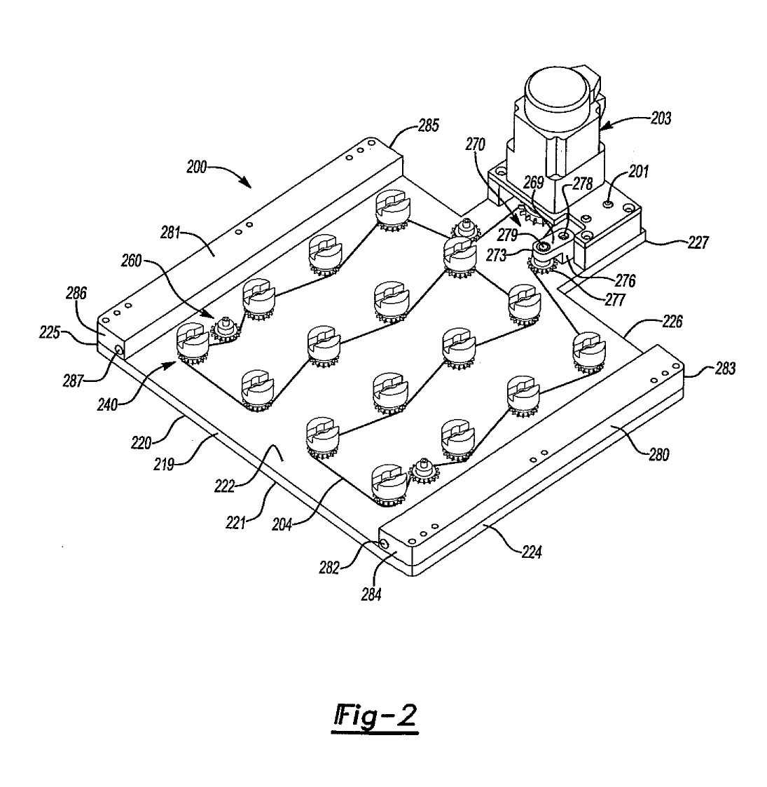

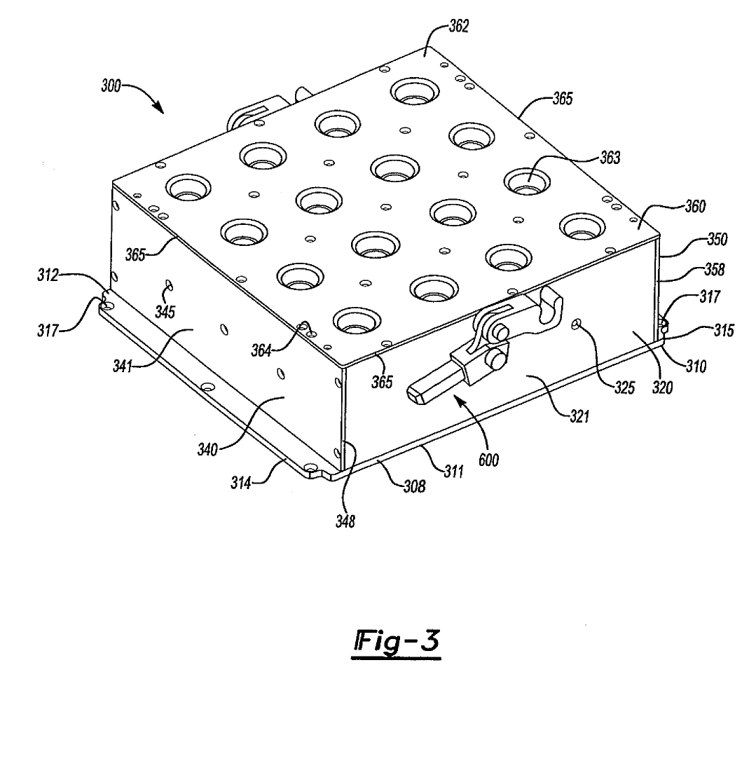

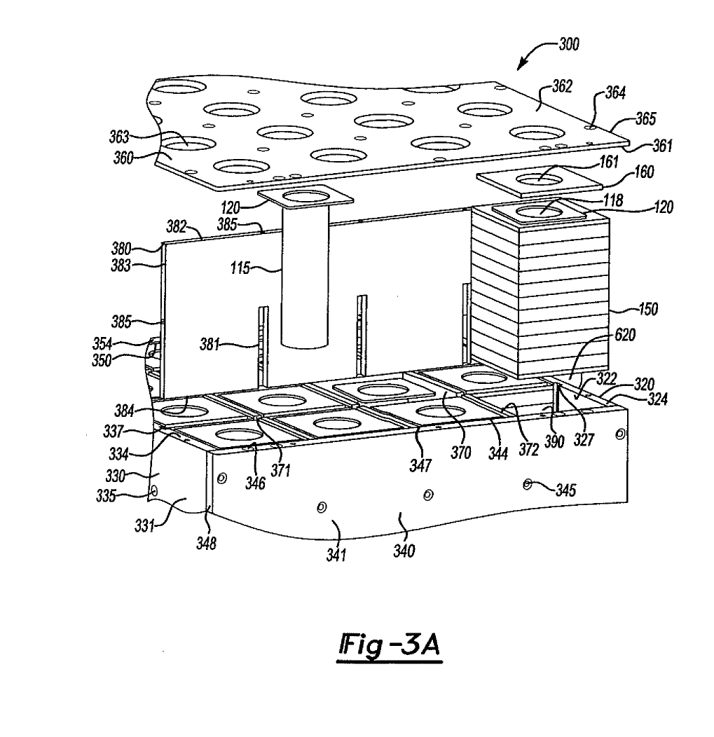

Operative connections are described below. Operative connection is made with an independently selected fastening means (e.g., fasteners 201 for base assembly 200 (see FIG. 2); fasteners 301 for chassis assembly 300 (see FIG. 3); and fasteners 401 for cover assembly 400 (see FIG. 1)). Preferably, a fastening means comprises fasteners (e.g., 301). Examples of a fastening means are a fastener (e.g., 301, cotter pin, rivet); an adhesive; a weld; a solder; a compression fitting; a spring; a magnet; or a combination thereof A fastener (e.g., 499) optionally has a portion (e.g., 497) that is externally screw-threaded (e.g., a screw and externally screw-threaded bolt), the fastener (e.g., 499) preferably being in operative connection with a fastening aperture (e.g., a hole (e.g., 356 in FIG. 3A) or groove) in a component of an invention apparatus, e.g., 5, the fastening aperture (e.g., 356 in FIG. 3A) optionally being internally screw-threaded and threadably engaged with an externally screw-threaded portion (e.g., 497) of fastener (e.g., 499).

FIG. 1 is a schematic illustration of a partial section view of an illustrative 16-sealed reactor variation of an invention apparatus 5 of the first embodiment. Variations of apparatus 5, wherein a plurality of sealed reactors 110 means sixteen sealed reactors 110, include, for example, modifying “plurality” to mean a greater or lesser number of sealed reactors 110. Other variations or modifications are contemplated and described herein.

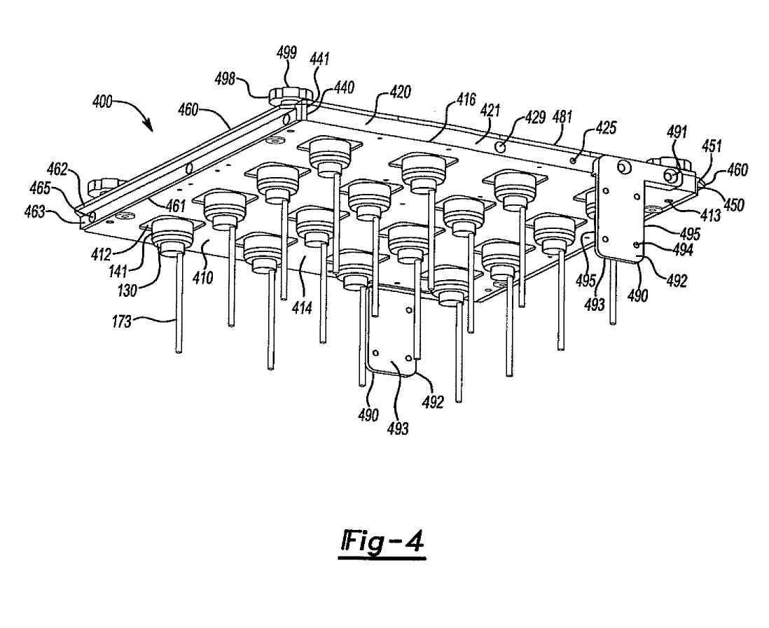

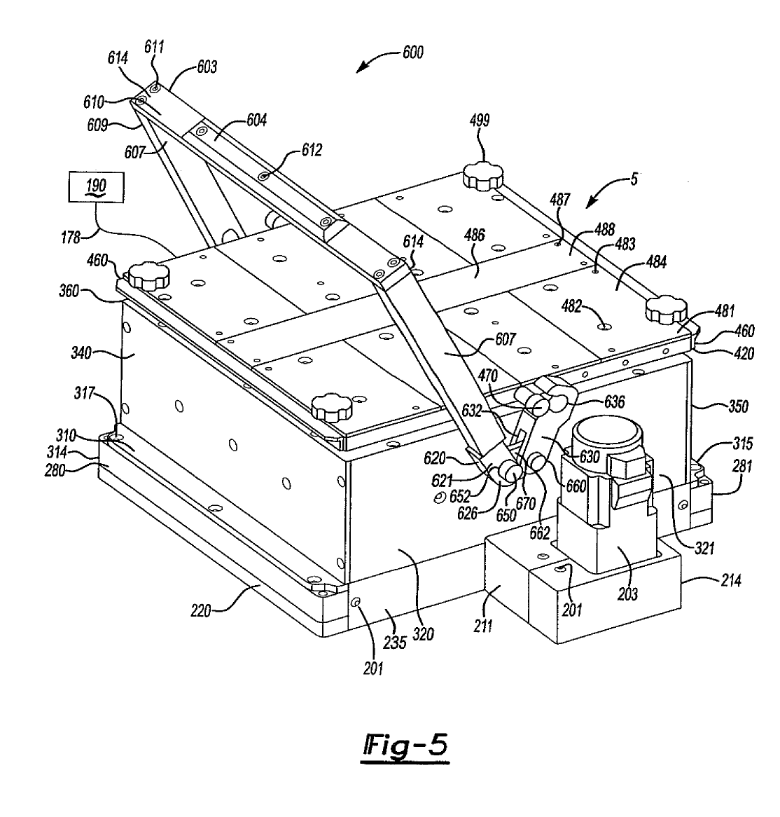

Apparatus 5 comprises sixteen sealed reactors 110 (two of which are shown in FIG. 1), sixteen stacked pluralities of discontinuous adiabatic thermal insulation material segments 150 (two stacked pluralities and a portion of a third stacked plurality are shown in FIG. 1), sixteen thermoelectrical temperature probes 173 (one of which is shown in FIG. 1), and a multi-channel (e.g., 16-channel) data device 190 (shown only in FIG. 5). Apparatus 5 also comprises a base assembly 200 (see FIG. 2 for greater detail), a chassis assembly 300 (see FIG. 3 for greater detail), a cover assembly 400 (see FIG. 4 for greater detail), and a locking assembly 600 (see FIG. 5 for greater detail). One or more of assemblies 200, 300, 400, and 600 may be omitted in variations of apparatus 5.

Additional contemplated modifications of apparatus 5 include, but are not limited to, replacing a plurality of segments 150 with a single continuous hollow (any shape as long as it defines a cavity that accommodates a sealed reactor 110) foam body, an aerogel composition, or replacing one or more of the pluralities of segments 150 with a single continuous foam block having one or more apertures, each sized to accommodate a reactor 110, and modifying (e.g., by shortening or eliminating), if necessary, internal walls 370 and/or 380 (see FIG. 3A); and replacing multi-channel data device 190 (shown only in FIG. 5) with one or more different data devices, or a combination thereof.

FIG. 1 shows two sealed reactors 110, one of which contains a removable liner 145 (discussed below). Each sealed reactor 110 independently comprises an aperture seal 130, a reactor body 115, and an O-ring 141. Reactor body 115 has an upper end or sealable aperture 118; a reactor wall 117 formed by a spaced-apart, and preferably generally parallel, pair of an exterior surface 111 and an interior surface 113; and a lower end 116. Lower end 116 terminates at, and preferably has affixed thereto, a cup-shaped insert 112. Skilled artisans understand that one can use something other than cup-shaped insert 112 at lower end 116. Preferably, the cup-shaped insert 112 has a permanent (e.g., by welding) or semi-permanent (e.g., with a thermoplastic adhesive, which may be removed or liquefied by melting) attachment to interior surface 113 proximate to lower end 116. At least a portion (described below) of exterior surface 111 of reactor body 115 between upper end 118 and lower end 116 independently comprises a thermally-insulating effective area (described below). The a thermally-insulating effective area or portion of exterior surface 111 may extend, preferably circumferentially, for all, or only part, of such exterior surface 111 between upper end 118 and lower end 116. Where only a portion of such exterior surface 111 is a thermally-insulating effective area, that portion preferably provides insulating coverage to a reaction mixture that may be contained in sealed reactor 110. Sealed reactor 110 also comprises a flange 120 disposed proximate to upper end 118, and distant from lower end 116 of exterior surface 111. Flange 120, preferably circumferential and outwardly-extending, is in operative connection with (e.g., by welding), and generally perpendicular to, reactor wall 117.

Aperture seal 130 preferably comprises a solid body having an upper segment 131, middle segment 133, and lower segment 136, preferably with a number of apertures 138 and 140 (not shown) defined therein (other configurations for aperture seal 130 are contemplated). Upper segment 131 has a diameter greater than diameters of middle segment 133 and lower segment 136 thereby functioning as a flange. Middle segment 133 has a diameter intermediate between the diameter of upper segment 131 and that of lower segment 136 and functions to provide, either by itself or, preferably, in conjunction with O-ring 141, sealing contact with inner surface 113 proximate to upper end or sealable aperture 118 of reactor body 115. Lower segment 136 has a diameter less than that of either upper segment 131 or middle segment 133 and functions to provide a venting insert into removable liner 145 (when used). Upper segment 131 has an upper surface 134 that functions as an upper surface for seal 130; and lower segment 136 has a lower surface 137 that functions as a lower surface for seal 130, said upper surface 134 and lower surface 137 being spaced apart from each other. Aperture 138 preferably constitutes a reclosable aperture. Aperture 140 (not shown) preferably constitutes a probe aperture, and is preferably spaced apart from, and generally parallel to, aperture 138. Both apertures 138 and 140 (not shown) preferably extend through aperture seal 130 from upper surface 134 to lower surface 137 and, when aperture 138 is at least partially open, and aperture 140 (not shown) lacks a probe 173, are in fluid communication with said surfaces 134 and 137. Upper surface 134 of upper segment 131 preferably has defined therein, especially proximate to its outermost extent, a plurality of fastening apertures 132 (not shown). Middle segment 133 preferably has defined therein a circumferential, preferably parallel to upper surface 134, O-ring channel 135.

Aperture 138, when it constitutes a reclosable aperture, comprises a cooperative combination of a door 139 (not shown) and a spring 142 (not shown). Door 139 (not shown) is preferably in hinged connection with a portion (not shown) of aperture seal 130. Spring 142 (not shown), connected to both door 139 (not shown) and aperture seal 130, provides a biased closure for aperture 138, and thereby, reactor 110. When desired, one may open door 139 (not shown) (e.g., with an instrument such as a needle) to provide fluid communication between upper surface 134 of upper segment 131 and lower surface 137 of lower segment 136, thereby facilitating fluid communication with interior surface 113 of reactor body 115.

An O-ring 141, when seated in O-ring channel 135 of aperture seal 130, provides sealing operative contact with both interior surface 113 of reactor body 115 proximate to upper end 118 of reactor body 115 and middle segment 133 of aperture seal 130.

Interior surface 113, cup-shaped insert 112, and aperture 118, all of reactor body 115, cooperate to define a volumetric space open at one end (i.e., at aperture 118). Inserting aperture seal 130 into aperture 118 effectively seals aperture 118 and defines an enclosed volumetric space that functions as a sealed reactor chamber 119 in sealed reactor 110. Sealed reactor chamber 119 is thus in fluid communication with at least a portion of interior surface 113 of reactor body 115 below O-ring 141.

Apparatus 5 preferably comprises at least one removable liner 145, preferably a glass vial. Each removable liner 145 has an upper end or aperture 148; a closed lower end 144 spaced apart from upper end 148; and a wall 149 that extends from upper end 148 to lower end 144. Wall 149 has a spaced apart exterior surface 146 and interior surface 147. Lower end 144 is preferably disposed in cup-shaped insert 112 of reactor body 115. Lower segment 136 of seal 130 preferably has at least a portion of its exterior circumferential surface disposed in, and spaced apart from, interior surface 147 proximate to aperture 148 so as to allow fluid communication (e.g., pressure equalization) between interior surface 147 and exterior surface 146 of wall 149. Sealed reactor chamber 119 includes an enclosed volumetric space defined by interior surface 147.

Each discontinuous adiabatic thermal insulation material segment 150 independently comprises a spaced-apart, preferably generally parallel, upper face 157 and lower face 156; and, preferably for all but a bottommost segment 150, an aperture 155. Aperture 155 provides fluid communication between said upper face 157 and lower face 156 and has an interior surface 154. Interior surface 154 provides adiabatic thermally insulating operative contact with at least a portion of the thermally-insulating effective area of exterior surface 111 as described above. Segments 150 may have a same or different thickness between faces 156 and 157.

Apparatus 5 comprises at least one sealing dam 160 (two and part of a third are shown in FIG. 1). Each sealing dam 160 comprises a spaced-apart, preferably generally parallel, upper face 163 and lower face 162; and at least one aperture 161. Aperture 161 provides fluid communication between upper face 163 and lower face 162 of sealing dam 160 and is in sealing operative contact with exterior surface 111, preferably proximate to upper end 118, of a reactor body 115. Preferably, lower face 162 is in operative contact with upper face 157 of an uppermost segment 150 (in at least one stacked plurality of segments 150).

Apparatus 5 preferably comprises a physico-chemical, preferably thermoelectrical temperature, probe 173 for each sealed reactor 110. Said probe 173 (e.g., a thermocouple) comprises a temperature sensing part 174, a shaft 175, and a wire 177 (not shown). At least a portion (not shown) of shaft 175 is disposed within, and in sealing operative contact with, aperture 140 (not shown) of aperture seal 130 of a sealed reactor 110. Temperature sensing part 174 is remote from wire 177 (not shown) and disposed in, and in sensing communication with, sealed reactor chamber 119 of sealed reactor 110. Each wire 177 (not shown) is disposed in a multi-wire bundle, preferably a 16-wire bundle 178 (shown only in FIG. 5), and is in data communication with a data device, preferably a different channel of a multi-channel data device 190 (see FIG. 5).

Each reactor 110 is disposed in a different stacked plurality of discontinuous adiabatic thermal insulation material segments 150. In each stacked plurality of segments 150, flange 120 is disposed between, and in operative contact with, a lower face 156 of one segment 150 and an upper face 157 of an adjacent below segment 150.

FIG. 1 shows certain components of base assembly 200 (see FIG. 2 for more detail) as follows: base plate 220; two stirrer assemblies 240, a guide sprocket assembly 260 (see FIG. 2; shown only by ring sprocket 267 and flanged head fastener 262), and rear support member 281. Base plate 220 comprises a spaced-apart, preferably generally parallel bottom face 221 and a top face 222. Base plate 220 defines a plurality of spaced-apart flanged apertures 223 (two of which are shown) and a plurality of spaced-apart flanged apertures 229 (not shown), which are essentially identical to flanged apertures 223. Said apertures 223 and 229 (not shown) provide fluid communication between bottom face 221 and top face 222 of base plate 220.

Each stirrer assembly 240 comprises a flanged cylindrical shaft 241, flanged ring bearings 244 and 245, a ring sprocket 247, a forked ring magnet 243, and a flanged head fastener 242. Each stirrer assembly 240 is operatively assembled and in operative contact with a different flanged aperture 223 (not shown) as follows. Flanged ring bearing 244 of each stirrer assembly 240 is disposed within a flanged aperture 223. Flanged cylindrical shaft 241 and flanged ring bearing 245 of each stirrer assembly 240 are disposed within the flanged aperture 223 and extend above top face 222 of base plate 220. The shaft 241 is also disposed within, and extends above, the flanged ring bearings 244 and 245, which establish operative contact between the shaft 241 and the flanged aperture 223. Above top face 222 of base plate 220, the flanged cylindrical shaft 241 is disposed within ring sprocket 247, forked ring magnet 243, and flanged head fastener 242. The fastener 242 is disposed within the ring sprocket 247, and forked ring magnet 243 and thereby establishes operative contact between the shaft 241 and the sprocket 247 and magnet 243.

Guide sprocket assembly 260 (see FIG. 2; shown only by ring sprocket 267 and flanged head fastener 262) comprises a flanged cylindrical shaft 261 (not shown), flanged ring bearings 264 and 265 (both not shown), a ring sprocket 267, and a flanged head fastener 262. Shaft 261, bearings 264 and 265 (all not shown), sprocket 267, and fastener 262 are preferably essentially identical to shaft 241, bearings 244 and 245 sprocket 247, and fastener 242, respectively. Each guide sprocket assembly 260 (see FIG. 2) is operatively assembled and in operative contact with a different flanged aperture 229 (not shown) as follows. Flanged ring bearing 264 (not shown) of each guide sprocket assembly 260 is disposed within a flanged aperture 229 (not shown). Flanged cylindrical shaft 261 and flanged ring bearing 265 (both not shown) of each guide sprocket assembly 260 are disposed within the flanged aperture 229 (not shown) and extend above top face 222 of base plate 220. The shaft 261 is also disposed within and extends above the flanged ring bearings 264 and 265 (all not shown), which establish operative contact between the shaft 261 (not shown) and the flanged aperture 229 (not shown). Above top face 222 of base plate 220, the flanged cylindrical shaft 261 (not shown) is disposed within ring sprocket 267 and flanged head fastener 262. The flanged head fastener 262 is disposed within the ring sprocket 267 and thereby establishes operative contact between the shaft 261 (not shown) and the sprocket 267.

FIG. 1 shows certain components of chassis assembly 300 (see FIGS. 3 and 3A for more detail) as follows: two fasteners 301; a chassis bottom plate 310; a left external wall 330; two of three front-to-back internal walls 370; and a chassis top plate 360. Chassis bottom plate 310 comprises spaced-apart and generally parallel bottom face 311 and top face 312. Said plate 310 comprises a left edge 309 (see FIG. 1) and defines three spaced-apart front-to-back channels 318 (two of which are shown) in top face 312 and a plurality of spaced-apart apertures 313 (two of which are shown). Apertures 313 provide fluid communication between top face 312 and bottom face 311. Left external wall 330 comprises a bottom edge 333. Each front-to-back internal wall 370 comprises a bottom edge 374. Bottom edges 374 are at least in operative contact with, preferably in operative connection to, different front-to-back channels 318. Chassis top plate 360 comprises spaced-apart and generally parallel bottom face 361 and top face 362. Chassis top plate 360 defines a plurality of apertures 363, each of which provides fluid communication between bottom face 361 and top face 362.

FIG. 1 shows certain components of cover assembly 400 (see FIG. 4 for more detail) as follows: a plurality of fasteners 401; a plurality of apertures 412; rear wall 450; support plate 410; one of two securing posts 470; one of eight access plates 481; and center plate 486. Support plate 410 comprises a bottom face 414.

Top face 362 of chassis top plate 360 is preferably spaced apart from bottom face 414 of support plate 410 so that cover assembly 400 (see FIG. 4) is beneficially spaced apart from chassis assembly 300 (see FIG. 3) as discussed below.

FIG. 1 shows certain components of locking assembly 600 (see FIG. 5 for more detail) as follows: one of two arms 607; one of two receiving members 620; one of two flanged handle posts 650; and one of two flanged hook posts 660.

Base assembly 200 of apparatus 5 is schematically illustrated in FIG. 2. Base assembly 200 comprises base plate 220; a plurality of fasteners 201 (see FIG. 5); right cover plate 235 (see FIG. 5); left cover plate 236 (not shown in any figure); front support member 280; rear support member 281; sixteen stirrer assemblies 240; a plurality of guide sprocket assemblies 260; an adjustable guide sprocket assembly 270; a drive belt 204; and a stirrer motor 203.

Base plate 220, described in part above for FIG. 1, comprises a plurality of fastening apertures 228 (not shown). Flanged apertures 223 (see FIG. 1), fastening apertures 228 (not shown), and flanged apertures 229 (not shown) are spaced apart from each other and provide fluid communication between bottom face 221 and top face 222 of base plate 220. Base plate 220 comprises a spaced-apart, preferably generally parallel, front edge 224 and rear edge 225. Base plate 220 also comprises a spaced-apart, preferably generally parallel, left edge 219 and right edge 226 that extend between front edge 224 and rear edge 225. Base plate 220 further comprises apron 227, which extends outwardly from right edge 226. Preferably, flanged apertures 223 (see FIG. 1) are preferably evenly spaced apart from each other, e.g., in a four row by four column arrangement, and from said edges 224, 225, 226, and 219. Said apertures 229 (not shown) are spaced apart from left edge 219, front edge 224, rear edge 225, and apron 227.

Adjustable guide sprocket assembly 270 comprises a support member 269, a flanged cylindrical shaft 271 (not shown), flanged ring bearings 274 and 275 (both not shown), a ring sprocket 277; and a flanged head fastener 272 (not shown). Shaft 271, bearings 274 and 275 (all not shown), ring sprocket 277, and said fastener 272 (not shown) are preferably essentially identical to said shaft 241, bearings 244 and 245 sprocket 247, and fastener 242, respectively, of stirrer assembly 240 (see FIG. 1). Support member 269 comprises spaced-apart and generally downwardly-extending lower end 276 and outwardly-extending end 273. Lower end 276 defines downwardly-extending fastening aperture 278 and outwardly extending end 273 defines downwardly-extending flanged aperture 279, which is spaced apart from and generally parallel to top face 222 of base plate 220. Flanged ring bearing 274 (not shown) of adjustable guide sprocket assembly 270 is disposed within flanged aperture 279. Flanged cylindrical shaft 271 and flanged ring bearing 275 (both not shown) are disposed within and extend below flanged aperture 279. The shaft 271 is also disposed within the flanged ring bearings 274 and 275 (all not shown), which establish operative contact between the shaft 271 and the flanged aperture 279. The flanged cylindrical shaft 271 (not shown) is also disposed within ring sprocket 277 and flanged head fastener 272 (not shown). The fastener 272 (not shown) is disposed within and extends above the sprocket 277 and establishes operative contact between the shaft 271 (not shown) and sprocket 277. The ring sprocket 277 is spaced apart from and proximate to top face 222 of base plate 220. Fastening aperture 278 is in operative connection via a fastener 201 (not shown) to a fastening aperture 228 (not shown) in apron 227 of base plate 220.

Front support member 280 comprises spaced-apart ends 283 and 284 and defines a plurality of fastening apertures 282. Rear support member 281 comprises spaced-apart ends 285 and 286 and defines a plurality of fastening apertures 287. Said support members 280 and 281 are preferably essentially identical to one another. Front support member 280 is in operative connection with top face 222 proximate and generally parallel to front edge 224 of base plate 220 and rear support member 281 is in operative connection with top face 222 proximate and generally parallel to rear edge 225 of base plate 220. Said members 280 and 281 are spaced apart from stirrer assemblies 240, guide sprocket assemblies 260, and adjustable guide sprocket assembly 270.

Right cover plate 235 (see FIG. 5) defines a plurality of spaced-apart fastening apertures 237 (not shown) and left cover plate 236 (not shown in any figure) defines a plurality of spaced-apart fastening apertures 234 (not shown). Fastening apertures 237 (not shown) of right cover plate 235 (see FIG. 5) are in operative connection via fasteners 201 (see FIG. 5) with a fastening aperture 282 (not shown) in end 283 of front support member 280 and a fastening aperture 287 (not shown) in end 285 of rear support member 281. Likewise, fastening apertures 234 (not shown) of left cover plate 236 (not shown in any figure) are in operative connection via fasteners 201 (not shown) with a fastening aperture 282 in end 284 of front support member 280 and a fastening aperture 287 in end 286 of rear support member 281.

Preferably, stirrer motor 203 is a Vexta BX230A-GFH2G5 alternating-current servo motor from Oriental Motor USA Corporation, Torrance, Calif., USA. Other stirrer motors may be readily used instead of the Vexta BX230A-GFH2G5 motor. Stirrer motor 203 is operatively connected via fasteners 201 (see FIG. 5) to, and disposed above, apron 227 of base plate 220.

Drive belt 204 is in operative contact with stirrer motor 203, stirrer assemblies 240, guide sprocket assemblies 260, and adjustable guide sprocket assembly 270. Stirrer motor 203 actuates and drives stirrer assemblies 240 via drive belt 204.

FIG. 3 schematically illustrates chassis assembly 300 and a partial view of locking assembly 600 (see FIG. 5 for details) of apparatus 5. Chassis assembly 300 comprises a chassis bottom plate 310; fasteners 301 (see FIG. 1); a right external wall 320; a left external wall 330 (see FIGS. 1 and 3A); a front external wall 340; a rear external wall 350; three front-to-back internal walls 370 (see FIG. 3A); three left-to-right internal walls 380 (see FIG. 3A); and a chassis top plate 360.

Chassis bottom plate 310, described in part above for FIG. 1, comprises spaced-apart and generally parallel left edge 309 (see FIG. 1) and right edge 308. Chassis bottom plate 310 comprises spaced-apart and generally parallel front edge 314 and rear edge 315. Front edge 314 and rear edge 315 are preferably, but need not be, longer than and generally perpendicular to left edge 309 (see FIG. 1) and right edge 308.

Chassis bottom plate 310 defines a plurality of spaced-apart apertures 313 (see FIG. 1) and fastening apertures 317 that independently provide fluid communication between top face 312 and bottom face 311 of plate 310. Apertures 313 (see FIG. 1) are spaced apart from said edges 314, 315, 309 (see FIG. 1), and 308 and preferably are evenly spaced apart from each other, e.g., in a four row by four column arrangement.

Front-to-back channels 318, described in part above for FIG. 1, in chassis bottom plate 310 are spaced apart from, and generally parallel to, each other, left edge 309 (see FIG. 1), right edge 308, and bottom face 311.

Chassis bottom plate 310 defines three left-to-right channels 319 (not shown) in top face 312. Left-to-right channels 319 (not shown) are spaced apart from, and generally parallel to, each other, front edge 314, rear edge 315, and bottom face 311. Left-to-right channels 319 (not shown) intersect, and preferably are generally perpendicular to, front-to-back channels 318 (see FIG. 1)

Right external wall 320 comprises spaced-apart and generally parallel inside face 322 (see FIG. 3A) and outside face 321. Right external wall 320 comprises spaced-apart and generally parallel side edges 328 (not shown) that are distal from each other. Right external wall 320 comprises spaced-apart and generally parallel bottom edge 323 (not shown) and top edge 324 (see FIG. 3A) that are distal from each other. Side edges 328 (not shown) preferably are perpendicular to bottom edge 323 (not shown) and top edge 324 (see FIG. 3A). Right external wall 320 defines a plurality of spaced-apart fastening apertures 325 and a post aperture 329 (not shown) that independently provide fluid communication between inside face 322 (see FIG. 3A) and outside face 321 of said wall 320. Right external wall 320 defines a plurality of edge fastening apertures 326 (not shown) in bottom edge 323 (not shown), top edge 324 (see FIG. 3A), and side edges 338 (not shown). Right external wall 320 defines three spaced-apart, generally parallel, top-to-bottom channels 327 (one is shown in FIG. 3A) in its inside face 322 (see FIG. 3A). Each top-to-bottom channel 327 (one is shown in FIG. 3A) spans generally vertically from top edge 324 (see FIG. 3A) to bottom edge 323 (not shown) of said wall 320. Top-to-bottom channels 327 (one is shown in FIG. 3A) in wall 320 are spaced apart from, and generally parallel to side edges 328 (not shown) and outside face 321. Additional details of right external wall 320 are described below for FIG. 3A.

Left external wall 330 (see FIGS. 1 and 3A), which preferably is essentially identical to right external wall 320, comprises spaced-apart and generally parallel inside face 332 (not shown) and outside face 331 (see FIG. 3A). Left external wall 330 also comprises spaced-apart and generally parallel side edges 338 (not shown) that are distal from each other. Left external wall 330 further comprises spaced-apart and generally parallel bottom edge 333 (see FIG. 1) and top edge 334 (see FIG. 3A) that are distal from each other. Side edges 338 (not shown) preferably are perpendicular to bottom edge 333 (see FIG. 1) and top edge 334 (see FIG. 3A). Left external wall 330 defines a plurality of spaced-apart fastening apertures 335 (see FIG. 3A) and a post aperture 339 (not shown) that independently provide fluid communication between inside face 332 (not shown) and outside face 331 (FIG. 3A). Left external wall 330 also defines a plurality of edge fastening apertures 336 (see FIG. 3A) in bottom edge 333 (see FIG. 1), top edge 334 (see FIG. 3A), and side edges 338 (not shown). Left external wall 330 also defines three spaced-apart, generally parallel, top-to-bottom channels 337 (one is shown in FIG. 3A) in its inside face 332 (not shown). Each top-to-bottom channel 337 (one is shown in FIG. 3A) spans generally vertically from top edge 334 (see FIG. 3A) to bottom edge 333 (see FIG. 1) of said wall 330. Top-to-bottom channels 337 (one is shown in FIG. 3A) in said wall 330 are spaced apart from, and generally parallel to side edges 338 and outside face 331 (see FIG. 3A). Additional details of left external wall 330 are described below for FIG. 3A.

Preferably, each top-to-bottom channel 337 (one is shown in FIG. 3A) in left external wall 330 (see FIGS. 1 and 3A) opposes, and is generally parallel to, a different one of top-to-bottom channels 327 (one is shown in FIG. 3A) in right external wall 320.

Each of front external wall 340 and rear external wall 350 lacks a post aperture (e.g., 329 and 339) but otherwise preferably is essentially identical to right external wall 320 or left external wall 330 (see FIGS. 1 and 3A). Accordingly, front external wall 340 comprises side edges 348 (one not shown), a bottom edge 343 (not shown), a top edge 344 (see FIG. 3A), an inside face 342 (not shown), an outside face 341, a plurality of fastening apertures 345; and a plurality of edge fastening apertures 346 (see FIG. 3A) in bottom edge 343 (not shown) and top edge 344 (see FIG. 3A) that respectively correspond to side edges 338 (not shown), a bottom edge 333 (see FIG. 1), a top edge 334 (see FIG. 3A), an inside face 332 (not shown), an outside face 331 (see FIG. 3A), a plurality of fastening apertures 335 (see FIG. 3A), and a plurality of edge fastening apertures 336 (see FIG. 3A) of left external wall 330 (see FIGS. 1 and 3A) described above. Additional details of front external wall 340 are described below for FIG. 3A. Likewise, rear external wall 350 comprises side edges 358 (one not shown), a bottom edge 353 (not shown), a top edge 354 (see FIG. 3A), an inside face 352 (not shown), an outside face 351 (not shown), a plurality of fastening apertures 355 (not shown), and a plurality of edge fastening apertures 356 (not shown) in bottom edge 353 (not shown) or top edge 354 (see FIG. 3A) that respectively correspond to side edges 338 (not shown), a bottom edge 333 (see FIG. 1), a top edge 334 (see FIG. 3A), an inside face 332 (not shown), an outside face 331 (see FIG. 3A), a plurality of fastening apertures 335 (see FIG. 3A), and a plurality of edge fastening apertures 336 (see FIG. 3A) of left external wall 330 (see FIGS. 1 and 3A) described above. Additional details of rear external wall 350 are described below for FIG. 3A.

Front external wall 340 defines three spaced-apart and generally parallel top-to-bottom channels 347 in inside face 342 (not shown) in a manner analogous to top-to-bottom channels 337 (one is shown in FIG. 3A) defined in inside face 332 (not shown) of left external wall 330 (see FIGS. 1 and 3A) as described above. Likewise, rear external wall 350 defines three spaced-apart and generally parallel top-to-bottom channels 357 (not shown) in inside face 352 (not shown) in a manner analogous to the top-to-bottom channels 327 defined in inside face 322 of (not shown) of right external wall 320 as described above. Preferably, each top-to-bottom channel 347 in front external wall 340 opposes, and is generally parallel to, a different one of top-to-bottom channels 357 (not shown) in rear external wall 350.

Bottom edge 323 (not shown) of right external wall 320 and bottom edge 333 (see FIG. 1) of left external wall 330 (see FIGS. 1 and 3A) are in respective operative connection with top face 312 of chassis bottom plate 310 proximate and parallel to left edge 309 (see FIG. 1) and right edge 308. Bottom edge 343 (not shown) of front external wall 340 and bottom edge 353 (not shown) of rear external wall 350 are in respective operative connection with top face 312 of chassis bottom plate 310 proximate and parallel to, but spaced apart from, front edge 314 and rear edge 315.

Chassis top plate 360, described in part above for FIG. 1, comprises four edges 365 that essentially define a square shape therefor (other shapes are contemplated also). Chassis top plate 360 defines sixteen spaced-apart apertures 363 and a plurality of fastening apertures 364 that independently provide fluid communication between bottom face 361 (see FIG. 1) and top face 362 of said plate 360. Apertures 363 are preferably evenly spaced apart from each other and edges 365, more preferably they are in a four row by four column arrangement.

FIG. 3A schematically illustrates a partial exploded view of chassis assembly 300. Sixteen compartments 390 (not all shown in FIG. 3A) are disposed in chassis assembly 300. FIG. 3A also shows a stacked plurality of adiabatic thermal insulation material segments 150; reactor bodies 115; flanges 120; and sealing dams 160 defining apertures 161, all described above. Each reactor body 115 defines a sealable aperture 118, Sealable apertures 118 shown in FIG. 3A preferably are substantially the same as sealable apertures 118 shown in FIG. 1 and flanges 120 shown in FIG. 3A preferably are substantially the same as flanges 120 shown in FIG. 1. Each reactor body 115 shown in FIG. 3A preferably is substantially the same as a reactor body 115 shown in FIG. 1. Flange 120 is connected to reactor body 115 in FIG. 3A proximate to sealable aperture 118 thereof; flange 120 is connected to reactor body 115 in FIG. 1 proximate to, but spaced apart from, sealable aperture 118 thereof.

Each front-to-back internal wall 370 comprises spaced-apart, generally parallel, side edges 373 (not shown) that are distal from each other. Each front-to-back internal wall 370 comprises spaced apart bottom edge 374 (see FIG. 1) and top edge 372 and defines three u-shaped (i.e., upward facing) generally vertical slots 371 spanning from top edge 372 to about half way to bottom edge 374 (see FIG. 1). The u-shaped slots 371 are preferably at ¼, ½, and ¾ lengths between side edges 373 (not shown) of a said wall 370. Each front-to-back internal wall 370 preferably defines a plurality of spaced-apart edge fastening apertures 375 (not shown) in top edge 372, side edge 373 (not shown), and bottom edge 374 (see FIG. 1).

Each left-to-right internal wall 380 defines three n-shaped (i.e., downward facing) generally vertical slots 381 instead of u-shaped slots 371 and is otherwise essentially identical to a front-to-back internal wall 370 described above. Accordingly, each left-to-right internal wall 380 comprises side edges 383 (one shown), a bottom edge 384 (one shown), and a top edge 382 and defines one or more spaced-apart edge fastening apertures 385 that are essentially identical to respective side edges 373, bottom edge 374, top edge 372, and edge fastening apertures 375 described above. The n-shaped slots 381 span from bottom edge 384 about half way up to top edge 382 at ¼, ½, and ¾ lengths between side edges 383 (one shown).

Different side edges 373 (not shown) of a same front-to-back internal wall 370 are at least in operative contact with, preferably in operative connection to, a different one of top-to-bottom channels 347 in inside face 342 (not shown) of front external wall 340 and a different opposing one of top-to-bottom channels 357 (not shown) in inside face 352 (not shown) of rear external wall 350. Bottom edges 374 of said walls 370 are in operative contact with, or connection to, front-to-back channels 318 (see FIG. 1) in top face 312 (see FIG. 1) of chassis bottom plate 310 (see FIG. 3) as described above.

Bottom edges 384 (one shown) of three left-to-right internal walls 380 are at least in operative contact with, preferably in operative connection to, different opposing left-to-right channels 319 (not shown) in top face 312 of chassis bottom plate 310 (see FIG. 3). Different side edges 383 (one shown) of a same left-to-right internal wall 380 are at least in operative contact with, preferably in operative connection with, a different one of top-to-bottom channels 337 (one is shown in FIG. 3A) in inside face 332 (not shown) of left external wall 330 and a different opposing one of top-to-bottom channels 327 (one is shown in FIG. 3A) in inside face 322 of right external wall 320.

The n-shaped slots 381 described above for left-to-right internal walls 380 are in operative contact with the u-shaped slots 371 described above for front-to-back internal walls 370 so that front-to-back internal walls 370 are at least in intersecting operative contact with, and disposed generally perpendicular to, left-to-right internal walls 380.

Top edges 324, 334, 344, and 354 of respective right external wall 320, left external wall 330, front external wall 340, and rear external wall 350 independently are in operative contact with, preferably operative connection to, bottom face 361 proximate and parallel to different edges 365 of chassis top plate 360.

Top edges 372 of front-to-back internal walls 370 and, top edges 382 at fastening apertures 385 of left-to-right internal walls 380 independently are in operative contact with, preferably operative connection to, bottom face 361 of chassis top plate 360.

Left external wall 330 is shown with outside face 331 and a fastening aperture 335, described above. Front external wall 340 is shown with outside face 341, side edges 348, fastening aperture 345, and top-to-bottom channels 347, described above. Chassis top plate 360 is shown with top face 362, fastening apertures 364, and apertures 363, described above. Receiving member 620 of locking assembly 600 (see FIG. 5) is shown.

Compartments 390 (not all shown in FIG. 3A) are defined by right external wall 320, left external wall 330, front external wall 340, rear external wall 350, front-to-back internal walls 370, and left-to-right internal walls 380. A stacked plurality of adiabatic thermal insulation material segments 150, a reactor body 115; flange 120; sealing dam 160 are disposed in a different one of compartments 390 (not all shown in FIG. 3A) as described above.

Preferably, diameters of apertures 363 in chassis top plate 360 are wide enough to allow removable liners 145 (see FIG. 1) to be placed through apertures 363 and into reactor bodies 115, and also to be removed therefrom. More preferably, diameters of apertures 363 in chassis top plate 360 are about the same as, but smaller than outside diameters of sealable apertures 118 of reactor bodies 115 (see FIG. 1) so that reactor bodies 115 (see FIG. 1), even without flanges 120, may not be removed from chassis assembly 300 (see FIG. 3) via apertures 363.

FIG. 4 schematically illustrates cover assembly 400. Cover assembly 400 comprises: a support plate 410; a plurality of fasteners 401 (see FIG. 1); two lift members 460; right wall 420; left wall 430 (not shown); front wall 440; rear wall 450; securing posts 470 (see FIG. 5); access plates 481 (a first four of which are shown in FIG. 4; all are shown in FIG. 5); center plate 486 (see FIG. 5); knobbed fasteners 499; and guide brackets 490. FIG. 4 also shows sixteen aperture seals 130, sixteen O-rings 141, and sixteen thermoelectrical temperature probes 173 as described above for FIG. 1.

Support plate 410 comprises spaced-apart and generally parallel bottom face 414 and top face 415 (not shown). Support plate 410 has four edges 416 that define a generally square profile for support plate 410 (other profiles are contemplated). Support plate 410 defines a plurality of spaced-apart apertures 412 and fastening apertures 413. Apertures 412 and, preferably apertures 413, are spaced apart from edges 416. Each aperture 412 and fastening aperture 413 provides fluid communication between bottom face 414 and top face 415 (now shown).

Each of lift members 460 comprises a spaced-apart and generally perpendicular bottom end 461 and outwardly-extending end 462. Each bottom end 461 has spaced-apart outside face 463 and inside face 464 (not shown). Each bottom end 461 defines a plurality of fastening apertures 465 that independently provide fluid communication between outside face 463 and inside face 464 (not shown).

Right wall 420 comprises spaced-apart and generally parallel outside face 421 and inside face 422 (not shown). Right wall 420 comprises a spaced-apart and generally parallel bottom edge 423 and top edge 424 (both not shown). Right wall 420 defines a plurality of spaced-apart fastening apertures 425 that independently provide fluid communication between outside face 421 and inside face 422 (not shown). Right wall 420 defines a plurality of spaced-apart edge fastening apertures 426 (not shown) in bottom edge 423 and top edge 424 (both not shown). Right wall 420 defines a post aperture 429 that provides fluid communication between outside face 421 and inside face 422 (not shown) of wall 420.

Left wall 430 comprises spaced-apart and generally parallel outside face 431 and inside face 432 (all not shown). Left wall 430 comprises a spaced-apart and generally parallel bottom edge 433 and top edge 434 (all not shown). Left wall 430 defines a plurality of spaced-apart fastening apertures 435 that independently provide fluid communication between outside face 431 and inside face 432 (all not shown). Left wall 430 defines a plurality of spaced-apart edge fastening apertures 436 in bottom edge 433 and top edge 434 (all not shown). Left wall 430 defines a post aperture 439 that provides fluid communication between outside face 431 and inside face 432 of wall 430 (all not shown).

Front wall 440 comprises spaced-apart and generally parallel outside face 441 and an inside face 442 (not shown). Front wall 440 comprises a spaced-apart and generally parallel bottom edge 443 and top edge 444 (not shown). Front wall 440 defines a plurality of spaced-apart fastening apertures 445 (not shown) that independently provide fluid communication between outside face 441 and inside face 442 (not shown). Front wall 440 defines a plurality of spaced-apart edge fastening apertures 446 (not shown) in bottom edge 443 (not shown) and top edge 444 (not shown) of wall 440.

Rear wall 450 comprises spaced-apart and generally parallel outside face 451 and inside face 452 (not shown). Rear wall 450 comprises a spaced-apart and generally parallel bottom edge 453 and top edge 454 (both not shown). Rear wall 450 defines a plurality of spaced-apart fastening apertures 455 (not shown) that independently provide fluid communication between outside face 451 and inside face 452 (not shown). Rear wall 450 defines a plurality of spaced-apart edge fastening apertures 456 (not shown) in bottom edge 453 (not shown) and top edge 454 (not shown) of wall 450.

Each access plate 481 comprises a spaced-apart and generally parallel top face 484 (see FIG. 5) and bottom face 485 (not shown). Each access plate 481 defines two access apertures 482 (see FIG. 5) and a plurality of fastening apertures 483 (see FIG. 5). Said apertures 482 (see FIG. 5) and 483 (see FIG. 5) are spaced apart from each other and independently provide fluid communication between top face 484 (see FIG. 5) and bottom face 485 (not shown).

Center plate 486 (see FIG. 5) comprises a spaced-apart and generally parallel top face 488 (see FIG. 5) and bottom face 489 (not shown). Center plate 486 (see FIG. 5) defines a plurality of fastening apertures 487 (see FIG. 5) that are spaced apart from each other and provide fluid communication between top face 488 (see FIG. 5) and bottom face 489 (not shown).

Each knobbed fastener 499 comprises a handle 498 and an externally screw-threaded post 497 (not shown) that is operatively connected to handle 498.

For illustration purposes, cover assembly 400 is shown in FIG. 4 as comprising two guide members 490, which are not part of apparatus 5 shown in FIG. 5. Each guide member 490 comprises a spaced-apart and generally parallel outside face 492 and inside face 493. Each guide member 490 has spaced-apart and generally parallel vertical edges 495 and defines a plurality of fastening apertures 491 and a plurality of fastening apertures 494. Said apertures 491 and 494 are spaced apart from each other and provide fluid communication between outside face 492 and inside face 493.

When guide members 490 are present in invention apparatus 5, preferably chassis assembly 300 (see FIG. 3) further comprises a plurality of guide bearings 393 (not shown). Preferably, at least four guide bearings 393 (not shown), preferably disposed in a two row by two column arrangement, are in operative connection with a plurality of fastening apertures 325 at outside face 321 of right external wall 320 (all in FIG. 3) and at least another four guide bearings 393 (not shown), preferably disposed in a two row by two column arrangement, are in operative connection with a plurality of fastening apertures 335 at outside face 331 of left external wall 330 (all in FIG. 3A). Inside faces 493 of different guide members 490 are spaced proximate to outside face 321 of right external wall 320 or outside face 331 of left external wall 330 and opposing vertical edges 495 of each guide member 490 are in vertically movable operative contact with, and disposed between, a different four guide bearings 393 (not shown).

Bottom edges 423, 433, 443, and 453 (all not shown) of respective right wall 420, left wall 430 (not shown), front wall 440, and rear wall 450 are in operative connection to top face 415 (not shown) proximate to different edges 416 of support plate 410 via fastening apertures 413 in support plate 410 and edge fastening apertures 426, 436, 446, and 456 (all not shown) in respective said bottom edges 423, 433, 443, and 453 (all not shown).

Access plates 481 (four of which are shown in FIG. 4; all shown in FIG. 5) and center plate 486 (see FIG. 5) are arranged in a edge-to-edge manner as shown in FIG. 5. Bottom faces 485 of access plates 481 are in operative connection to at least one of top edges 424 and 434 (both not shown) of respective right wall 420 and left wall 430 (not shown) and, for four of said plates 481, to top edge 444 or top edge 454 (both not shown) of respective front wall 440 and rear wall 450. Each operative connection is made via a fastening aperture 483 (see FIG. 5) in an access plate 481 and a respective edge fastening aperture 426, 436, 446, or 456 (all not shown) in respective top edges 424, 434, 444, or 454 (all not shown) of respective right wall 420, left wall 430 (not shown), front wall 440, or rear wall 450.

Bottom face 489 (not shown) of center plate 486 (see FIG. 5) is in operative connection to top edges 444 and 454 (both not shown) of respective front wall 440 and rear wall 450. Each operative connection is made via a fastening aperture 487 (see FIG. 5) in center plate 486 (see FIG. 5) and an edge fastening aperture 446 or 456 (both not shown) in respective top edges 444 or 454 (both not shown) of respective front wall 440 or rear wall 450.

Access plates 481 (four of which are shown in FIG. 4) and center plate 486 (see FIG. 5) are spaced apart from, and generally parallel to, support plate 410 by said walls 420, 430, 440, and 450.

Inside faces 464 (not shown) of bottom ends 461 of different ones of lift members 460 are in operative connection with, and generally parallel to, a different one of outside face 441 of front wall 440 or outside face 451 of rear wall 450. Each operative connection is made via a fastening aperture 465 in a lift member 460 and a fastening aperture 445 or 455 (both not shown) in front wall 440 or rear wall 450, respectively.

Each securing post 470 (see FIG. 5) is in operative connection with a different post aperture 429 in right wall 420 or post aperture 439 (not shown) in left wall 430 (not shown). Preferably, each securing post 470 (see FIG. 5) has an externally screw-threaded end 471 (not shown) and either each post aperture 429 and 439 is independently internally screw-threaded or an internally screw-threaded fastener (e.g., a nut) independently is employed that preferably is disposed against inside face 422 (not shown) of right wall 420 or inside face 432 (not shown) of left wall 430 (not shown). Alternatively, instead of two securing posts 470, a one-piece rod (not shown) may be employed and disposed between, and having portions that cross through, post apertures 429 and 439. Each externally screw-threaded end 471 (not shown) is threadably engaged with a different internally screw-threaded post aperture 429 or 439 or a different internally screw-threaded fastener (e.g., a nut).

Each aperture seal 130 is disposed within a different aperture 412 in support plate 410. Fastening apertures 132 (not shown) in flanged top portion 131 (see FIG. 1) of each aperture seal 130 are in operative connection to apertures 412 in support plate 410. Preferably, each aperture 412 in support plate 410 is sequentially vertically aligned with a different aperture 363 in chassis top plate 360, sealed reactor 110, aperture 313 in chassis bottom plate 310, and stirrer assembly 240 (as shown in FIG. 1).

An external view of invention apparatus 5 is schematically illustrated in FIG. 5. In FIG. 5, right wall 420 of cover assembly 400 (see FIG. 4) is shown in dark shading, whereas right wall 420 is shown without shading in FIG. 4. As shown in FIG. 5, invention apparatus 5 comprises right cover plate 235; fasteners 201; stirrer motor 203; base plate 220; front support member 280; and rear support member 281, all described above; a guide sprocket access cover 211; and a drive sprocket access cover 214, all of base assembly 200. Invention apparatus 5 comprises chassis bottom plate 310; right external wall 320; left external wall 330 (see FIGS. 1 and 3A); front external wall 340; rear external wall 350; and chassis top plate 360, all of chassis assembly 300. Invention apparatus 5 comprises two lift members 460; eight access plates 481; center plate 486; and four knobbed fasteners 499, all of cover assembly 400. Invention apparatus 5 comprises a multi-channel data device 190 and a multi-wire bundle, preferably a 16-wire bundle 178; and locking assembly 600.

The 16-wire bundle 178 is comprised of sixteen wires 177 (not shown) as described above. Channels of the multi-channel data device 190 is in sequential operative connection and data communication with a different one of 16 wires 177 (not shown) of 16-wire bundle 178 and of thermoelectrical temperature probes 173 (see FIG. 1).

Locking assembly 600 comprises handle 610; receiving members 620 (one not shown); latch members 630 (one not shown); flanged handle posts 650 (one not shown); flanged hook posts 660 (one not shown); and hinge members 670 (one not shown).

Handle 610 comprises cross member 603, grip member 604, and two arms 607. Each arm 607 comprises a male end 608 (not shown) and a female end 609. Female end 609 defines fastening apertures 613 (not shown). Cross member 603 comprises spaced-apart and distal ends 614 and defines a plurality of fastening apertures 611 (three not shown). Grip member 604 defines a plurality (e.g., three) of fastening apertures 612.

Each receiving member 620 (one not shown) comprises a female end 621 and two spaced-apart and generally parallel finger members 626 that are distal from female end 621. Each female end 621 defines an arm aperture 622 (not shown). Each finger member 626 defines a post aperture 627 (not shown). Post apertures 627 (not shown) are generally aligned with each other.

Each latch member 630 (one not shown) defines a channel 636 and comprises two spaced-apart and generally parallel finger members 632 that are distal from channel 636. Each finger member 632 defines a post aperture 633 (not shown). Post apertures 633 (not shown) are generally aligned with each other.

Each flanged handle post 650 (one not shown) comprises spaced-apart and distal fastening (preferably externally screw-threaded) end 651 (not shown) and flanged end 652. Each flanged hook post 660 (one not shown) comprises spaced-apart and distal fastening (preferably externally screw-threaded) end 661 (not shown) and flanged end 662.

Each hinge member 670 defines a spaced-apart hook post aperture 671 (not shown) and handle post aperture 672 (not shown).

Grip member 604 is in operative connection (via fastening apertures 612) to fastening apertures 611 (three not shown), which are defined by a middle portion (not shown) of cross member 603 that is spaced apart from ends 614. Ends 614 of cross member 603 (via fastening apertures 611) are in operative connection to fastening apertures 613 (not shown) in female ends 609 of a different one of arms 607 to form handle 610.

Male ends 608 (not shown) of arms 607 are in operative connection (e.g., via a compression fitting) to arm aperture 622 (not shown) of a female end 621 of a different one of receiving members 620.

A handle post aperture 672 (not shown) of each hinge member 670 is disposed between, and generally aligned with, post apertures 627 (not shown) of finger members 626 of a different one of receiving members 620. A different flanged handle post 650 is disposed within, and is in rotatable operative contact with, the post apertures 627 (not shown) of receiving member 620 and handle post aperture 672 of hinge member 670. Fastening end 651 of each flanged handle post 650 is in operative connection to a different one of post aperture 329 (not shown) in right external wall 320 or post aperture 339 (not shown) in left external wall 330 (see FIGS. 1 and 3A); a fastening means, e.g., a rivet or internally screw-threaded nut, that is disposed within chassis assembly 300 (see FIG. 3); or a combination thereof. Handle 610 is preferably movable between a generally vertical position (not shown), where cross member 603 is disposed above securing posts 470 and a generally horizontal position (not shown), where cross member 603 is disposed in front of front external wall 340.

A hook post aperture 671 (not shown) of each hinge member 670 (one not shown) is disposed between, and generally aligned with, post apertures 633 of finger members 632 of a different one of latch members 630. A different flanged hook post 660 is disposed within, and is in rotatable operative contact with, the post apertures 633 (not shown) and the hook post aperture 671 (not shown). Fastening end 662 of a different one of flanged hook posts 660 is in operative connection to a fastening means, e.g., a rivet, cotter pin/aperture, or internally screw-threaded nut, and is proximate to and spaced apart from an outside face 321 of right external wall 320 or an outside face 331 (see FIG. 3A) of left external wall 330 (see FIGS. 1 and 3A).

Access apertures 482, fastening apertures 483, and top face 484 of access plates 481 are shown, as described above. Fastening apertures 487 and top face 488 of center plate 486 are shown, as described above.

Fastening apertures 282 (see FIG. 2) in front support member 280 and fastening apertures 287 (see FIG. 2) in rear support member 281 are in operative contact with bottom face 311 (see FIG. 3) of, and are in operative connection to fastening apertures 317 in, chassis bottom plate 310 proximate to front edge 314 (see FIG. 3) and rear edge 315 (see FIG. 3), respectively, thereby securing chassis assembly 300 (see FIG. 3) to base assembly 200 (see FIG. 2).

Beneficially cover assembly 400 (see FIG. 4) functions, in part, as a means for generally simultaneously placing O-rings 141 (see FIG. 4), aperture seals 130 (see FIG. 4), or both in sealing operative contact with interior surfaces 113 (see FIG. 1) proximate to sealable aperture 118 (see FIG. 1) of reactor bodies 115 (see FIG. 1). For example, such generally simultaneously placement and sealing operative contact may be manually made employing lift members 460 of cover assembly 400 (see FIG. 4). Cover assembly 400 (see FIG. 4) may then be secured by placing, if necessary, handle 610 in a generally horizontal position as described above and manually placing channel 636 of each latch member 630 of locking assembly 600 in operative contact with a different securing post 470 of cover assembly 400 (see FIG. 4). Then handle 610 is moved from the generally horizontal position (not shown) to a generally vertical position (not shown), as described above.

Alternatively, such generally simultaneously placement and sealing operative contact may be robotically made, preferably employing guide members 490 (see FIG. 4) and guide bearings 393 (not shown, described above) in operative connection to invention apparatus 5 as described above. Preferably, a robot arm (e.g., model 9692 from Tecan Group, AG, see Example 1) is placed in operative connection with fastening apertures 494 (see FIG. 4) in guide members 490 (see FIG. 4). The robot arm (e.g., model 9692) is activated to generally simultaneously place opposite vertical edges 495 (see FIG. 4) of each guide member 490 (see FIG. 4) in vertically movable contact between guide bearings 393 (not shown, described above) while generally simultaneously placing O-rings 141 (see FIG. 4), aperture seals 130 (see FIG. 4), or both in sealing operative contact with interior surfaces 113 (see FIG. 1) proximate to sealable aperture 118 (see FIG. 1) of reactor bodies 115 (see FIG. 1).

Preferably, each O-ring 141 (see FIG. 4) independently is in operative contact with a lubricant (e.g., a silicone-based grease).

Externally screw-threaded post 497 (not shown) of each knobbed fastener 499 is threadably engaged with a different edge fastening aperture 346 (preferably internally screw-threaded) in top edge 344 of front external wall 340 (all shown in FIG. 3A) or a different edge fastening aperture 356 (preferably internally screw-threaded) in top edge 354 of rear external wall 350 (all shown in FIG. 3A).

Beneficially in invention apparatus 5, cover assembly 400 (see FIG. 4) is spaced apart from, and not in direct operative contact with, chassis assembly 300 (see FIG. 3) or reactor bodies 115 (see FIG. 1) as described above. Direct heat conduction, if any, from chassis assembly 300 (see FIG. 3), and thus from reactor bodies 115 (see FIG. 1), to cover assembly 400 (see FIG. 4) is thereby prevented, which improves temperature sensing accuracy of invention apparatus 5 as described below.

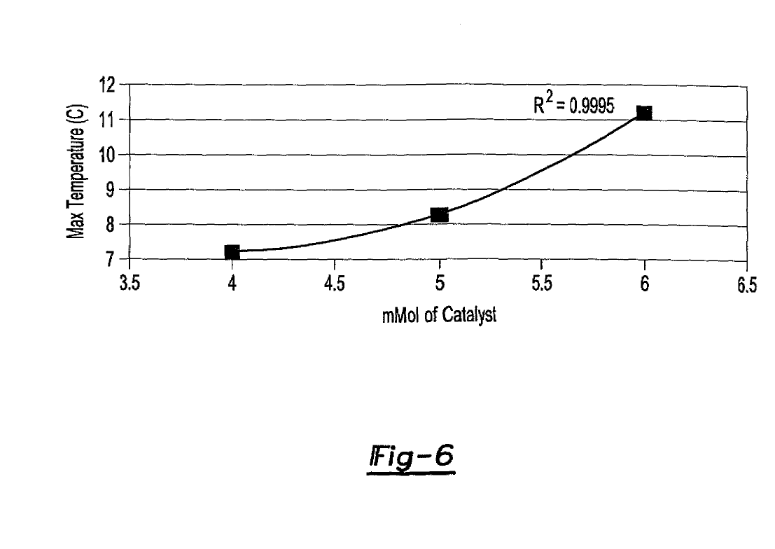

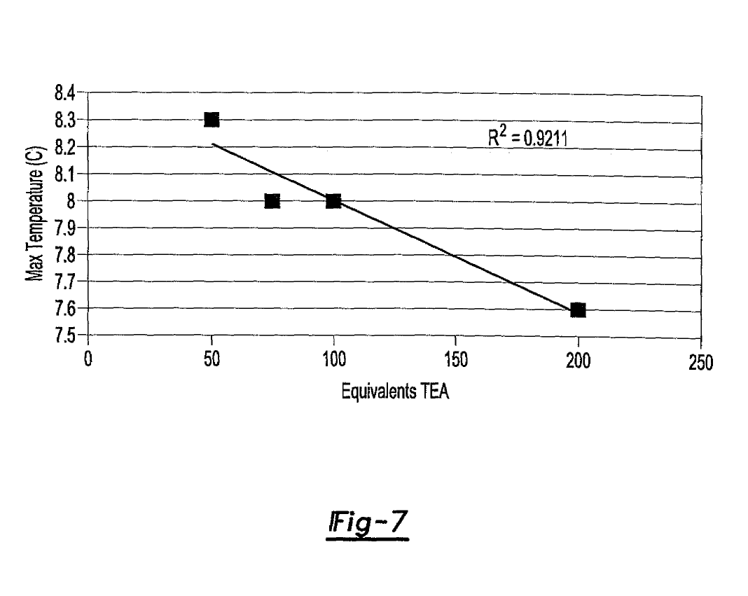

Examples of an invention method of the second embodiment employing invention apparatus 5 (see FIG. 5) are provided below in Examples 1 and 2. Certain temperature data for Example 2 are schematically illustrated in FIGS. 6 and 7.

FIG. 6 graphically illustrates the effects of varying catalyst concentration on maximum exotherm temperature reached for homopolymerizations of 1-octene with a Ziegler Natta catalyst CAT-1 in the presence of 50 mole equivalents of TEA, as described in Example 2. FIG. 6 shows that increasing CAT-1 catalyst concentration results in a non-linear increase in maximum exotherm temperature reached.

FIG. 7 graphically illustrates the effects of varying TEA mole equivalents (compared to titanium) on maximum exotherm temperature reached for homopolymerizations of 1-octene with a Ziegler Natta catalyst CAT-1, as described in Example 2. FIG. 7 shows that increasing TEA mole equivalents results in a linear decrease in maximum exotherm temperature reached.

Prior to, during, or after an invention method of the second embodiment employing an invention apparatus (e.g., 5), reaction ingredients such as reactants (e.g., the first and second reactants of the second embodiment) may be added to, or aliquots of reaction mixtures may be withdrawn from, sealed reactor chambers (e.g., 119) of sealed reactors (e.g., 110). During said addition or withdrawal, the sealed reactor chambers (e.g., 119) may become temporarily unsealed (i.e., a state of fluid communication between an exterior surface (e.g., 111) and interior surface (e.g., 113) of a reactor body (e.g., 115) may briefly exist). Such additions preferably are by independent injection of reactants, preferably either as neat liquids or as a solution in a solvent. Beneficially, a reclosable aperture (e.g., 138) in an aperture seal (e.g., 130) provides repeated access (e.g., by a needle-tipped syringe) to a sealed reactor chamber (e.g., 119), and allows reaction ingredients to be added thereto, or aliquots to be removed therefrom multiple times; after each addition or withdrawal, the reclosable aperture (e.g., 138) automatically closes.

Each element, component, step, or other variable feature of an invention apparatus of the first embodiment or invention method of the second embodiment is independently selected unless otherwise indicated herein. For example, each first reactant is chosen without regard to a choice for any other first reactant; each physico-chemical sensor is chosen without regard to a choice for any other physico-chemical sensor; and etc.

The phrase “adiabatically thermally insulated” means passively inhibiting heat transfer (e.g., between reaction mixtures in different sealed reactors (e.g., 110). In contrast to passively inhibiting heat transfer is active heating or cooling, which relate to, respectively heating or cooling effects of, for example, an active electrical heating element or an active circulating liquid coolant. The present invention apparatus and method do not require, and preferably exclude, active heating or active cooling, and preferably both.

The term “crosses through” means traverses entirely, including opposite surfaces, such that the opposite surfaces are capable of being in fluid communication with each other.

The phrase “in fluid communication” refers to engaging in, or currently being available for, movement of a liquid (including a solution), gas, or both, as circumstances indicate.

The term “operative contact” refers to a direct (i.e., there is/are no intermediary component(s)) or indirect (i.e., there is an intermediary component(s)) physical and functional contact between two materials, wherein the materials are not directly or indirectly fastened to each other. Examples of such materials are components of an invention apparatus (e.g., a reactor body 115) and reactants and other reaction ingredients. For example, magnet (e.g., 243) of a magnetic stirrer assembly (e.g., 240) may be in magnetic operative contact with a reaction mixture that is disposed in a sealed reactor chamber (e.g., 119) of a sealed reactor (e.g., 110) sequentially via a magnetic stir bar disposed in the sealed reactor chamber (e.g., 119). A “sealing operative contact” is a form of operative contact that prevents fluid communication.

The term “operative connection” means operative contact, as defined above, or a direct or indirect fastened contact between two materials. An operative connection is made with a fastening means (e.g., 301), wherein each fastening means (e.g., 301) independently is as described above.

A “thermally-insulating operative contact” inhibits transfer of heat from one sealed reactor chamber (e.g., 119) to another sealed reactor chamber (e.g., 119), although heat may be transferred from a material (e.g., a reaction mixture) disposed in a sealed reactor chamber (e.g., 119) to at least part of the sealed reactor (e.g., 110) in which the sealed reactor chamber (e.g., 119) is disposed.

A “thermally-insulating effective area” means an extent of an exterior surface (e.g., 111) of a reactor body (e.g., 115), or a reactor body (e.g., 115) and, optionally, one or more aperture seals (e.g., 130) of a sealed reactor (e.g., 110) that is sufficient, when in thermally-insulating operative contact with an adiabatic thermal insulation means (e.g., 150), to prevent a material transfer of heat from a first sealed reactor chamber (e.g., 119) of one sealed reactor (e.g., 110) to a second sealed reactor chamber (e.g., 119) of another sealed reactor (e.g., 110), i.e., to prevent heat in the first sealed reactor chamber (e.g., 119) to materially affect temperature in an adjacent second sealed reactor chamber (e.g., 119). Such a material transfer of heat is considered prevented for present purposes according to a following test employing first and second reaction mixtures and a control mixture, which are disposed in sealed reactor chambers (e.g., 119) in adjacent first, second, and third sealed reactors (e.g., 110), respectively. In an invention method of the second embodiment, when the first reaction mixture produces an exothermic reaction, material heat transfer from the first reaction mixture to the second reaction mixture is considered prevented if, in any one of ten trial runs, the first reaction mixture increases temperature of the second reaction mixture by less than 2.0° C., preferably less than 1.0° C., more preferably less than 0.5° C. above temperature of the control reaction mixture, wherein the control reaction mixture comprises the same reaction ingredients in substantially the same amounts as which comprises the second reaction mixture. The second sealed reactor (e.g., 110) is adjacent to both the first and third sealed reactors (e.g., 110), but the first and third sealed reactors (e.g., 110) are not adjacent to one another.

The phrase “in data communication” means participating in a one way or two way exchange of information.

The phrase “in sensing communication” means participating in a heat transfer via direct physical contact.

The term “plurality” means a number N, wherein N is an integer of from 2 to about 1000. In some embodiments, N is an integer of 1000 or less and at least 4; at least 8; at least 16; at least 32; at least 64; or at least 88. In other embodiments, N is an integer of at least 2 and 500 or less; 384 or less; 192 or less; or 100 or less. The phrases “at least one” and “one or more” are synonymous and mean an integer of 1 or higher, preferably up to a number N. Likewise, the phrase “at least two” means an integer of 2 or higher, preferably up to a number N.

During a reaction, sealed reactors (e.g., 110) may be shaken, swirled, or otherwise agitated, for example, to facilitate mixing of reaction mixtures contained in the sealed reactors (e.g., 110). Preferably, reaction mixtures are stirred (e.g., with a stir bar). Magnetic stirrer assemblies (e.g., 240) and other conventional stirrer assemblies may be placed in operative contact with the sealed reactor chambers (e.g., 119) of the sealed reactors (e.g., 110) and employed to stir the reaction mixtures disposed in said chambers (e.g., 119).

A reactor body (e.g., 115) comprises an interior surface (e.g., 113) and defines one or more sealable apertures (e.g., 118) and has an exterior surface (e.g., 111) and an interior surface (e.g., 113). When a sealable aperture (e.g., 118) is open (e.g., when it is not in sealing operative contact with a closed aperture seal, e.g., 130, or when in operative contact with an aperture seal, e.g., 130, having an opened aperture (e.g., 138 or 140), the sealable aperture (e.g., 118) establishes fluid communication between the exterior surface (e.g., 111) and the interior surface (e.g., 113). Preferably, sealable apertures (e.g., 118) are not in direct physical contact with any reaction mixture disposed in a sealed reactor (e.g., 110). Preferably, the entire interior surface (e.g., 113), more preferably the entire reactor body (e.g., 115), independently consists essentially of, a chemically-resistant material. Preferably, the chemically-resistant material has a Brinell Hardness Number (BHN, or more commonly, HB) of 40 HB or higher, as determined by ASTM International test protocol ASTM E10. An interior surface (e.g., 113) of a reactor body (e.g., 115) may be smooth or contoured (e.g., dimpled or ribbed), coated with a chemically resistant material or uncoated. Examples of chemically-resistant materials are glass, a metal (e.g., titanium), a metal alloy (e.g., stainless steel and HASTELLOY® of Haynes International, Inc.), and a chemically resistant polymeric material (e.g., a fiberglass reinforced plastic, a polystyrene-butadiene rubber, a neoprene rubber, and acrylonitrile-butadiene copolymer), polyetheretherketone (PEEK), polytetrafluoroethylene (PTFE), fluoroelastomer, and perfluoroelastomer (PFE)).

A reactor body (e.g., 115) comprises one piece (e.g., 115) or two or more pieces (not shown) that are in sealing operative connection with each other. Preferred is a one piece reactor body (e.g., 115) or a two-piece reactor body (not shown). More preferred is a one piece reactor body (e.g., 115).

A removable liner (e.g., 145) optionally may be, and preferably is, disposed in a sealed reactor (e.g., 110). Preferred removable liners (e.g., 145) are comprised of glass, e.g., a glass vial (e.g., 145).

Each sealed reactor chamber (e.g., 119) independently has a volume of about 1000 mL or less and preferably at least about 1 mL, wherein volume is measured without any part of a temperature sensor (e.g., 173) being disposed in the sealed reactor chamber (e.g., 119). Preferably, volume of each sealed reactor chamber (e.g., 119) independently is about 300 mL or less; about 150 mL or less; about 60 mL or less; about 30 mL or less; or about 15 mL or less. Also preferably, volume of each sealed reactor chamber (e.g., 119) independently is about 2 mL or more; about 5 mL or more; about 10 mL or more; or about 20 mL or more.

Turning to an aperture seal (e.g., 130), an “aperture seal” means any material that may be disposed in, and forms a sealing operative contact with, a sealable aperture (e.g., 118) that is defined in a reactor body (e.g., 115) of a sealed reactor (e.g., 110). Examples of preferred aperture seals (e.g., 130) are an O-ring (e.g., 141); a plug (e.g., 130), optionally having a portion (not shown) that is an externally screw-threaded plug; and a septum. An O-ring defines an aperture that, when in sealing operative contact with, for example, a thermoelectrical temperature probe (e.g., 173), may be characterized as a probe aperture. A particular sealable aperture may be in sealing operative contact, sequentially or non-sequentially, with more than one aperture seals such as, for example, where an aperture seal (e.g., 130) is in sealing operative contact with an O-ring (e.g., 141) and at least the O-ring (e.g., 141) is in sealing operative contact with a sealable aperture (e.g., 118). Preferably, the material comprises a chemically resistant metal or a chemically resistant polymeric material described above. Preferably, an aperture seal (e.g., 130) defines at least one aperture (e.g., 138 and 140), more preferably at least one reclosable aperture (e.g., 138 or a puncture in a septum), at least one probe aperture (e.g., 140), or a combination thereof. Where there are two or more apertures (e.g., 138 and 140), they are spaced apart from each other in an aperture seal (e.g., 130). Optionally, an aperture seal (e.g., 130) may further define an O-ring channel (e.g., 135) that is in sealing operative contact with an O-ring (e.g., 141).

Beneficially, sealing dams (e.g., 160) prevent fluid communication between adiabatic thermal insulation materials (e.g., 150) and a source (e.g., a stock solution) of a reaction ingredient (e.g., a reactant).

In some embodiments, the invention apparatus further comprises a means for establishing and maintaining sealed reactor spacing and orientation for supporting each of the sealed reactors (e.g., 110) in thermally operative contact with one or more adiabatic thermal insulation means (e.g., 150) and, preferably, in a generally vertical orientation. Examples of a means for establishing and maintaining sealed reactor spacing and orientation are an adiabatic thermal insulation means that may function as a means for generally vertically supporting sealed reactors (support means), e.g., at least one (e.g., N) stacked plurality of segments 150 and a polyurethane foam block that has a plurality of apertures dimensioned for being in adiabatically thermally-insulating operative contact with an exterior surface (e.g., 111) of a reactor body (e.g., 115) of a sealed reactor (e.g., 110) and a bottom portion (e.g., 112) of the reactor body (e.g., 115). Other examples of the means for establishing and maintaining sealed reactor spacing and orientation are a chassis assembly 300 (see FIG. 3) and a cover assembly 400 (see FIG. 4). Combinations of two or more such means for establishing and maintaining sealed reactor spacing and orientation are also contemplated.

In some embodiments, the invention apparatus further comprises a liquid handling robot (not shown) and one or more liquid reservoirs (not shown). The invention apparatus may be readily adapted for use with a liquid handling robot (not shown) and one or more liquid reservoirs (not shown). Preferred liquid handling robots (not shown) are commercially available systems, which are available from a number of suppliers such as, for example, TECAN® GENESIS® Robotic Sample Processor and XMP 6000 (Tecan Group AG, Lausanne, Switzerland) and FlexDrop™ PLUS Precision Reagent Dispenser (PerkinElmer Life And Analytical Sciences, Inc., Waltham, Mass., USA). Preferred liquid reservoirs (not shown) are commercially available solvent bottles as well as containers provided for liquids used with a commercially available liquid handling robot (not shown).

An invention apparatus and method of the present invention employs physico-chemical sensors (e.g., 173) to measure physico-chemical characteristics such as, for example, temperature, pressure, an amount of a gas (e.g., a gas reactant or gas reaction product), pH or an amount of water in sealed reactor chambers (e.g., 119). In such embodiments, physico-chemical sensors other than temperatures sensors (e.g., 173) may be readily employed in place of (i.e., substituted for), or in combination with (i.e., together in a same sealed reactor (e.g., 110) or in different sealed reactors (e.g., 110)), temperature sensors (e.g., 173). Examples of such other physico-chemical sensors are pressure transducers (e.g., a subminiature pressure transducer series PXM600 and others from Omega Engineering, Inc., Stamford, Conn., USA), pH sensors, and chemical sensors, e.g., sensors for measuring hydrogen (e.g., in-line process hydrogen monitor HY-OPTIMA™ 700 (H2scan Corp., Valencia, Calif., USA), chlorine, oxygen, carbon dioxide, hydrocarbons, isocyanates, olefins, and water. In such embodiments, a data device (e.g., 190) comprises at least a means for obtaining physico-chemical data communicated by such physico-chemical sensors (not shown). Each data device (e.g., 190) is in data communication with at least one physico-chemical sensor (e.g., 173).

A temperature sensor (e.g., 173) means any device that is capable of accurately measuring (as described below) temperature, or a proxy thereof (e.g., voltage or electrical resistance) of a reaction mixture disposed in a sealed reactor (e.g., 110) of an invention apparatus (e.g., 5) during an invention method of the second embodiment, and communicating (e.g., via a wire or radio frequency (RF) transmission) resulting temperature measurement data to a data device (e.g., 190). Examples of temperature sensors are RF-transmitting temperature sensors (not shown) and, preferably, thermoelectrical temperature probes (e.g., 173). An example of an RF-transmitting temperature sensor (not shown) and an RF temperature data device (not shown) is the ThermaAssureRF™ Wireless Temperature Recorder (Evidencia LLP, Memphis, Tenn., USA). Preferred thermoelectrical temperature probes (e.g., 173) are a thermocouple, a thermistor, and a resistance temperature device.

Preferably each temperature sensing part (e.g., 174) is in sensing communication with only one reaction mixture. Preferably the temperature sensing parts (e.g., 174), more preferably all parts, of thermoelectrical temperature probes (e.g., 173) are not in direct physical contact with reactor bodies (e.g., 115) of the sealed reactors (e.g., 110).

A data device (e.g., 190) means any device for temporarily or permanently obtaining physico-chemical data (e.g., temperature data), preferably physico-chemical reaction data (e.g., temperature reaction data) by receiving a communication of such data from a physico-chemical sensor (e.g., 173). Preferably, the data device is a multi-channel data manger (e.g., 190), wherein each channel may essentially simultaneously receive physico-chemical data from a different one of a plurality of sealed reactors (e.g., 110), wherein the physico-chemical data received by each channel may be the same or different. Physico-chemical data are obtained by a data device (e.g., 190) when the data become available for use in an invention method of the second embodiment (or a variation thereof) by a skilled artisan. For example, physico-chemical data are obtained when they are received, displayed (e.g., electronically on a display monitor or with ink on paper), listed, printed, plotted, processed (e.g., with an algorithm), transmitted, or any combination thereof, by the data device (e.g., 190). Preferably, physico-chemical data comprises temperature data or temperature data and time data. Examples of a temperature data device (e.g., 190) are a volt meter; an ohm meter; a RF-receiving temperature data device; a temperature meter, which may comprise a thermometer or, preferably, a means of converting thermoelectrical temperature outputs measured in volts or ohms into temperature values in ° C.; or a printer; a plotter; a computer; or an electronic display monitor capable of printing, plotting, algorithmically processing or storing, or displaying at least temperature data. Physico-chemical data (e.g., temperature data), time data, or a combination thereof may be stored in an electronic memory for later retrieval or processing.

A preferred function of sealed reactors (e.g., 110) is, for example, to prevent fluid communication between reaction mixtures when reaction mixtures are disposed in sealed reactor chambers (e.g., 119) of different ones of the sealed reactors (e.g., 110). Another preferred function of sealed reactors (e.g., 110) is to prevent loss of heat from the reaction mixtures due to evaporation of one or more ingredients (e.g., a reactant or solvent) thereof, especially during an exothermic reaction.

Preferably, when a reaction mixture is disposed in a sealed reactor chamber (e.g., 119) of a sealed reactor (e.g., 110) comprised of a reactor body (e.g., 115) having an exterior surface (e.g., 111) and an upper end (e.g., 118) and a lower end (e.g., 116), at least a portion of the exterior surface (e.g., 111) between the upper end (e.g., 118) and the lower end (e.g., 116) independently comprises a thermally-insulating effective area. The thermally-insulating effective area may extend, preferably circumferentially, only part or, preferably, all, of such exterior surface (e.g., 111) between the upper end (e.g., 118) and the lower end (e.g., 116). Where only a portion of such exterior surface (e.g., 111) is a thermally-insulating effective area, that portion or thermally-insulating effective area preferably provides insulating coverage to the reaction mixture as described herein. Preferably, the portion or thermally-insulating effective area extends at least about one quarter of the way, more preferably at least about half way, still more preferably at least about three quarters of the way, still more preferably at least about nine tenths of the way up from the lower end (e.g., 116) and the upper end (e.g., 118). Preferably, a bottom (e.g., 112) of the reactor body (e.g., 115) is disposed on and in adiabatically thermally-insulating operative contact with an adiabatic thermal insulation means (e.g., 150). The thermally-insulating effective area may variably relate to how full the sealed reactor chamber (e.g., 119) is with a reaction mixture.

An adiabatic thermal insulation means (e.g., 150) is a continuous thermal insulation means (not shown), a discontinuous thermal insulation means (e.g., 150), or a mixture thereof. A continuous adiabatic thermal insulation means (not shown) refers to a adiabatic thermal insulation material (e.g., 150 or a polyurethane foam block having two or more apertures, each disposed for holding a sealed reactor (e.g., 110)), a vacuum thermal insulation means (not shown), or a combination thereof that independently is in thermally-insulating operative contact with thermally-insulating effective areas (described above) of exterior surfaces (e.g., 111) of reactor bodies (e.g., 115) of at least two, preferably each, of sealed reactors (e.g., 110) of an invention apparatus.

A discontinuous thermal insulation means (e.g., 150) refers to an adiabatic thermal insulation material (a discontinuous material, e.g., 150), a vacuum thermal insulation means (a discontinuous vacuum means, not shown), or a combination thereof that is in thermally-insulating operative contact with a thermally-insulating effective area (described above) of an exterior surface (e.g., 111) of a reactor body (e.g., 115) on only one sealed reactor (e.g., 110). Preferably, each discontinuous thermal insulation means (e.g., 150) is a discontinuous thermal insulation material (e.g., 150), which may be the same or different. Each discontinuous vacuum thermal insulation means may be the same or different. Two or more discontinuous adiabatic thermal insulation means (e.g., 150) may or may not be physically separated from each other, e.g., by a partition means (e.g., 370 and 380).

In some embodiments, a thermally-insulating effective area (described above) of an exterior surface (e.g., 111) of a reactor body (e.g., 115) of one sealed reactor (e.g., 110) of an invention apparatus may be in thermally-insulating operative contact with two or more different discontinuous adiabatic thermal insulation materials (e.g., 150).

A vacuum thermal insulation means (not shown) refers to any body defining an interior cavity under a vacuum having a pressure of less than 0.00001 atmospheres, which is achievable by employing, for example, a diffusion pump or a turbo molecular pump (e.g., respectively, a DIP 50000, water cooled, oil diffusion pump or a MAG W 300/600 turbo molecular pump, both from Oerlikon Leybold Vacuum GmbH, Cologne, Germany). Preferably, the interior cavity of a vacuum thermal insulation means (not shown) will contain a porous adiabatic thermal insulation material, such as aerogel or syntactic foam.

An adiabatic thermal insulation material (e.g., 150) has a thermal conductivity k of less than 1.0 Watt per meters-kelvin (W*m⁻¹*K⁻¹). Thermal conductivity is calculated according to formula (I):

k=(Q/t)*{L/(A*ΔT)} (I)

wherein k is thermal conductivity, Q is a quantity of heat transmitted, t is the time period over which the quantity of heat Q is transmitted through a thickness L in a direction normal to a surface of area A due to a temperature difference ΔT. The symbol “*” indicates multiplication and the symbol “/” indicates division. In other embodiments, k is less than 0.5 W*m⁻¹*K⁻¹; less than 0.2 W*m⁻¹*K⁻¹; or less than 0.1 W*m⁻¹*K⁻¹.

Preferred adiabatic thermal insulation materials (e.g., 150) are an aerogel, a polymer or interpolymer, syntactic foam, thermal fibers, or a wood. Examples of aerogels include silica-, melamine-, alumina-, resorcinol-formaldehyde-, and carbon-based aeorgels. Preferably, the syntactic foam comprises a glass microballoon-epoxy foam, a glass microballoon-aluminum foam, or a cenosphere-aluminum foam. Preferably, the thermal fiber is incorporated into a thermal textile comprising a fiberglass textile, a polymer or interpolymer fiber textile, a carbon fiber textile (e.g., KEVLAR®, E. I. Du Pont de Nemours and Company, Wilmington, Del., USA), or a wool textile. Preferably, wood comprises dried wood, more preferably cork or dried balsa wood).

More preferably, adiabatic thermal insulation materials (e.g., 150) are comprised of, still more preferably consist essentially of, a polymer or interpolymer, optionally in the form of a fiber board or comprising a textile as mentioned above. Also more preferably, said adiabatic thermal insulation materials (e.g., 150) are polyurethane foam, polystyrene foam, low density polyethylene, low density polystyrene, a rubber comprising a polystyrene-butadiene rubber, neoprene, or acrylonitrile-butadiene copolymer.

For a particular exothermic reaction, an invention apparatus employing an adiabatic thermal insulation means (e.g., 150) will beneficially allow a reaction mixture disposed in a sealed reactor (e.g., 110) thereof to experience a larger temperature increase (i.e., provide greater temperature sensing accuracy) than would be possible if the reaction mixture would be disposed in a sealed reactor (e.g., 110) set in, or comprised of, a metal insulating block (whether or not it is actively heated or cooled). This is because the metal insulating block would readily conduct heat away from a reaction mixture contained in the sealed reactor (e.g., 110) disposed therein, thereby attenuating any temperature increase or decrease of the reaction mixture during an exothermic or endothermic reaction, respectively. In contrast, the sealed reactor (e.g., 110) of the invention apparatus is thermally insulated by an adiabatic thermal insulation means (e.g., 150) having a thermal conductivity k of less than 1.0 W*m⁻¹*K⁻¹. Such adiabatic thermal insulation means (e.g., 150) of the present invention minimizes loss of heat from a reaction mixture in a sealed reactor (e.g., 110) by thermal conduction. Accordingly, larger differences between a starting baseline temperature (e.g., room temperature or room temperature plus temperature increase due to friction of stirring as discussed later) and higher maximum (or minimum) temperatures of reaction mixtures in an instant sealed reactor chamber (e.g., 119) are attainable and accurately measurable with the instant invention apparatus and method. Thus, the instant invention provides for more accurate comparisons of reactions and greater sensitivities for detecting small exotherms (e.g., less than 10° C. increases) than are achievable with a prior art apparatus employing a metal insulating block. These more accurate comparisons and greater sensitivities translate into better parallel reaction optimization results (e.g., better understanding of effects on efficiency of a catalyst of changing reaction variables).

Further as mentioned above, active heating and cooling (e.g., via mechanical and electrical systems) of a metal insulating block would increase inaccuracy of sensing (i.e., measuring) temperature of a reaction mixture disposed therein by increasing rate of heat transfer between the reaction mixture and the metal insulating block. The present invention apparatus (e.g., 5) and method, employing an adiabatic thermal insulation means, beneficially accurately measures temperatures of weakly exothermic reactions (i.e., less than 10° C. increases), and even endothermic reactions, that are run essentially simultaneously in sealed reactors (e.g., 110) that are adjacent to sealed reactors (e.g., 110) having strongly exothermic reactions (greater than 30° C. increases) disposed therein.

In a method of the second embodiment, any reaction mixture that produces, upon reaction, an exotherm temperature increase of 2° C. or more above a baseline temperature or an endothermic temperature decrease of 2° C. or more below a baseline temperature. In other embodiments, the measurement of temperature is accurate to detect a 1° C. or more; 0.5° C. or more; or 0.1° C. or more temperature change above, or below, a baseline temperature. In some embodiments, an exotherm temperature increase is 500° C. or less, 300° C. or less, or 200° C. or less above a baseline temperature. In other embodiments, displayed or recorded temperature data for reaction mixtures may show a minimum exotherm of a 2° C. increase and a maximum exotherm of less than a 10° C. increase over starting baseline temperatures. In still other embodiments, at least one reaction shows a maximum exotherm of less than a 10° C. increase over starting baseline temperature and at least one other reaction mixture shows a maximum exotherm of 30° C. or more and 500° C. or less.

Baseline temperature typically is room temperature or, when a component (e.g., a forked ring magnet 243, which may potentially generate heat of friction when spinning within aperture 313) of an invention apparatus generates heat (e.g., stirrer assembly 240), room temperature plus any temperature increase due to heat generated by the component that generates heat. Such temperature increase may be readily measured by measuring temperature change from room temperature of a dummy mixture comprising all but one of the reactants of the invention method of the second embodiment, wherein a volume of an inert ingredient (e.g., a solvent) is added instead of the one missing reactant (e.g., a same volume of isopar E may be added instead of a volume of 1-octene used below in Examples 1 or 2 to form a dummy mixture).

The invention apparatus and method contemplate using, for example, exothermic reactions and endothermic reactions, catalyzed reactions and stoichiometric reactions (i.e., non-catalyzed reactions wherein none of the at least reactants is a catalyst), reactions where there is one reactant (e.g., autocatalytic reactions), reactions where there are two reactants, and reactions where there are more than two reactants, and any combination thereof. Preferred are exothermic reactions. More preferred are catalyzed exothermic reactions. Still more preferred are catalyzed homopolymerization reactions and curing reactions such as, for example, epoxy curing reactions.

An invention apparatus and method are useful for comparing and optimizing reaction variables. Examples of stoichiometric reaction variables are choices of two or more reactants. Examples of catalyzed reaction variables are choices of reactants, e.g., catalyst and substrate and, optionally, co-catalyst, organic catalyst modifiers (e.g., internal donors and external donors), procatalysts and their activators, and co-substrate(s). Further examples of stoichiometric and catalyzed reaction variables are solvent(s), emulsifier(s), order of addition of reaction ingredients, concentrations of reaction ingredients, stoichiometries of reaction ingredients, atmosphere in contact with a reaction mixture, and impurity profiles of the reaction ingredients. Large numbers of experiments are required to productively test the effects of so many reaction variables on physico-chemical data profiles, preferably temperature-time data profiles and, thus, it is desirable to employ a parallel multiple, essentially simultaneous reaction paradigm. For example, temperature data, or, preferably, temperature and time data, produced for one of a plurality of exothermic reactions may be compared to temperature data, or temperature and time data, respectively, produced for another one of the plurality of the exothermic reactions of an invention method to evaluate effects of changes to reaction variables on the exothermic reactions.

In some embodiments, comparisons of physico-chemical data, preferably temperature data or temperature data and time data, are done in real time, i.e., while a reaction that produces such data is running. In other embodiments, the obtained physico-chemical data are stored (e.g., in a computer memory as an electronic image or listing, or on paper as a listing printout or as a graphical plot of data), and such data may be then compared, or processed (e.g., data corrected for baseline temperature drift, if any, or statistically processed) and resulting processed data compared, afterwards.

Preferably, an invention method further comprises the step of comparing physico-chemical data, preferably reaction temperature data (e.g., temperature values or proxies thereof such as voltage values from a thermocouple or ohm values from a resistance temperature detector) of one of the reaction mixtures to a same type of physico-chemical data, preferably reaction temperature data of another of the reaction mixtures. More preferably, the invention method further comprises the step of comparing reaction temperature data and reaction time data of one of the reaction mixtures to reaction temperature data and reaction time data of another of the reaction mixtures. Reaction temperature data and reaction time data for different reaction mixtures may be compared by, for example, comparing changes in temperature over time for the reactions. For example, maximum rates of temperature increase (e.g., degrees Celsius per minute), times to maximum temperature, or both may be compared. Optionally, reaction temperature data, reaction time data, or a combination thereof may be recorded, processed, displayed, or a combination thereof.

Preferably, reactions of an invention method are essentially simultaneous. More preferably, reactions of an invention method are essentially simultaneous and physico-chemical data, preferably temperature data (and reaction time data) for each of the reaction mixtures is generated essentially simultaneously. Essentially simultaneous reactions are reactions where the time periods of their respective reaction coordinates (i.e., a time period including the time from reaction start to the time at reaction end) overlap, however briefly. Preferably, the respective reaction coordinates substantially (e.g., for at least 90% of the time of one reaction coordinate) overlap.

In some embodiments, at one point in time, a sealed reactor (e.g., 110) contains a mixture comprising a first reactant (e.g., a polymerization catalyst) and, optionally, other reaction ingredients, but not a second (or last added) reactant (e.g., not a liquid monomer), and then after the one point in time, the second (or last added) reactant is contacted to the first reactant in the mixture, wherein the first reactant may be the same or different and the second (or last added) reactant may be the same or different.

The term “reactant” means a reactive chemical compound. Examples of reactants are a catalyst, substrate for the catalyst, stoichiometric reactant (e.g., a carboxylic acid), and a gas (e.g., hydrogen). In reactions where there are more than two reactants, preferably there are from 3 to 5 reactants, more preferably 3 reactants. Preferably, a reactant is a liquid at 25° C.

Preferably, a catalyst is described as such in Handbook of Commercial Catalysts: Heterogeneous Catalysts, by Howard F. Rase, CRC Press, 1^{st} edition, Mar. 24, 2000; or Homogeneous Catalysis: Mechanisms and Industrial Applications, by Sumit Bhaduri and Doble Mukesh, Wiley-Interscience Press, 1^{st} edition, Feb. 25, 2000. Illustrative catalysts and substrates include, but are not limited to polymerization catalysts and substrates; catalysts and substrate for epoxy curing; hydrogenation catalysts and substrates; hydroformylation catalysts and substrates; methane dehydroaromatization catalysts; carbonylation catalysts and substrates; reduction catalysts and substrates; and oxidation catalysts and substrates, respectively. Catalysts may be formed or activated in situ. For example, a procatalyst may be converted to a catalyst in situ by reaction with an activator and an inactive form of a catalyst may be converted to an active form of the catalyst in situ by reaction with a cocatalyst.

In some embodiments, reactants are catalysts and substrates and catalysts are polymerization catalysts and substrates are monomers and, optionally, co-monomers. Preferably, suitable monomers, polymerization catalysts, and details regarding polymerization processes are found or referenced in “Polymer Handbook”, 4^{th} Ed, Brandrup, Immergut, and Grulke, Eds., Wiley, 1999; and “Copolymerization”, G. E. Ham, Ed., High Polymers, Vol. XVIII, Interscience, 1964. Particular examples of polymerization catalyst systems that can be used in the invention method include magnesium chloride or silica supported Ziegler Natta titanium catalysts (precursors of which may or may not be modified with Lewis base donors), single site, metallocene, and post metallocene catalysts. In some instances, catalyst precursors will be activated with a co-catalyst such as trialuminum alkyl, borane, and borates. In some embodiments, polymerization catalysts are evaluated by polymerizing monomers to yield homopolymers. In some embodiments, polymerization catalysts are evaluated by co-polymerizing a monomer and at least one co-monomer to yield interpolymers (e.g., copolymers, terpolymers, etc.).

In a preferred embodiment of an invention method, changes in physico-chemical characteristics, preferably temperature, or changes in temperature over time such as, for example, those described above in the Background and incorporated here by reference, of a plurality of catalyzed exothermic reactions are compared. Preferably, such comparisons comprise evaluating efficiencies of catalysts. For purposes of the present invention, “efficiency” of a catalyst refers to maximum temperature increase (i.e., the difference in ° C. of maximum temperature reached during reaction minus temperature at the start of the reaction); the maximum rate of temperature increase (in ° C. per minute) during the reaction (i.e., the highest slope of a line fitted to reaction temperature data on a y-axis and reaction time on a x-axis); or a combination thereof. All other things being equal, the higher the maximum temperature increase, maximum rate of temperature increase, or both, the higher the catalyst efficiency.

In some embodiments, the method of the second embodiment further comprises the steps of: adjusting a variable of at least two of a plurality of exothermic catalyzed reactions in the sealed reactors, repeating at least steps (a) and (b), and determining if catalyst efficiency or yield, purity, or a functional characteristic of a product is improved. Examples of such functional characteristics are viscosity, solubility, biodegradability, glass transition temperature, melting point (e.g., Tₘ) impact resistance, abrasion resistance, electrical conductivity, thermal stability, stability to ultraviolet radiation, fiber forming ability, and modulus.

Preferably, all biological reactions, e.g., in vitro enzyme-catalyzed processes for synthesizing peptides, polynucleosides, and polynucleotides, are excluded from the present invention method.

### Preparation 1

### Conventional Preparations of Ziegler Natta Catalysts

To a 20 mL vial is added with stirring a slurry of a support material (e.g., silica or MgCl₂) in a hydrocarbon solvent (e.g., isopar-E), a solution of a chlorinating source such as an alkyl chloride (e.g., butyl chloride), metal chloride (e.g., vanadium trichloride), or an aluminum alkyl dichloride (e.g., ethyl aluminum dichloride, propyl aluminum dichloride, or butyl aluminum dichloride) in the hydrocarbon solvent, and stirring is continued overnight. Then a titanium source (e.g., titanium tetrachloride or a titanium tetraalkoxide (e.g., titanium tetramethoxide, titanium tetraethoxide, titanium tetraisopropoxide, or titanium tetrabutoxide) is added, and the resulting preparation is aged for an aging period of time (e.g., from 6 to 30 hours). The molar ratio of the support material, chlorinating source, and titanium is from 6 to 160; from 2.0 to 50; and from 0.5 to 12, respectively, in the preparation and the preparation comprises a concentration of from 2 to 48 mM of titanium. The slurry of support material and solution of chlorinating source may be added to the 20 mL vial robotically. Using the procedure of Preparation 1, a stock preparation of Ziegler Natta titanium catalyst sample CAT-1 is prepared and separately a stock preparation of Ziegler Natta titanium catalyst sample CAT-2 is prepared.

### Example 1

Purpose: to rapidly test efficiencies of Ziegler Natta titanium catalyst sample CAT-1 by screening CAT-1 in reactions to polymerize 1-octene

Formulation, dilution and screening parameters are programmed using LIBRARY STUDIO™ (Symyx Technologies, Santa Clara, Calif., USA) designs. Temperature data output from sixteen thermocouples are essentially simultaneously processed for electronic display using two NI PCI-6013 A/D multifunction data acquisition cards and Measurement Studio® software (both from National Instruments Corporation, Austin, Tex., 78759, USA). Two J-KEM® shakers (J-Kem Scientific, Inc., 6970 Olive Boulevard, Saint Louis, Mo., 63130 USA) are used for catalyst formulation and delivery. Up to six removable J-KEM® reaction blocks (J-Kem Scientific, Inc.) may be essentially simultaneously used with each shaker, each reaction block being dimensioned for fitting onto a conventional microtiter plate footprint. One reaction block on a first shaker holds eight 20 mL vials and another reaction block on a second shaker holds twenty-four 4 mL vials. Vials are fitted with cap seals and material is robotically transferred between vials of different reaction blocks. A stock catalyst preparation can be diluted to a desired concentration using a conventional liquid handling robot comprised of a robotic arm (model 9692) and two Carvo® XLP 3000 syringe pumps, all from Tecan Group AG, supra. The liquid handling robot can also deliver a measured amount of the stock catalyst preparation to sixteen 20 mL glass vials (e.g., 145) inserted in sealed reactors 110 of the 16-sealed reactor variation of apparatus 5 of the first embodiment illustrated in FIGS. 1 to 5 and described previously. In the 16-sealed reactor variation of apparatus 5 employed in Example 1, each reactor body 115 comprises stainless steel and has a 3.175 cm outer diameter and a 3.033 cm inner diameter. Each aperture seal 130 comprises PEEK and each O-ring 141 comprises a fluoroelastomer.

In a first validation experiment, sixteen replicate aliquots of the stock preparation of CAT-1 of Preparation 1 are separately robotically diluted in sixteen 20 mL glass vials (e.g., 145) with isopar-E to give sixteen diluted preparations each having a 6 mM concentration of titanium and a catalyst loading of 6 μmol of titanium. Triethylaluminum (TEA) is added. Then 10 mL aliquots of neat 1-octene (“C8”) are added to each of the sixteen 20 mL glass vials (e.g., 145). Polymerizations of the 1-octene aliquots with these sixteen replicate catalyst dilutions gives an average exothermic response of 42.4° C. with a standard deviation of 2.0° C.

In a second validation experiment, an additional sixteen replicate aliquots of the stock preparation of CAT-1 of Preparation 1 are used to prepare sixteen additional diluted preparations of CAT-1 as before and 5 mL aliquots of 1-octene diluted with 5 mL of isopar is added. Polymerizations of the 1-octene aliquots with these additional sixteen replicate catalyst dilutions gives an average exothermic response of 19.0° C. with a standard deviation of 1.2° C.

Results from the procedure of Example 1 indicate that replacing a portion of a substrate with an inert solvent proportionally reduces temperature increases resulting from exothermic reaction of the substrate with a Ziegler Natta titanium catalyst.

### Example 2

Purpose: to rapidly test efficiencies of Ziegler Natta titanium catalyst samples CAT-1 and CAT-2 by independently screening CAT-1 and CAT-2 in reactions to polymerize 1-octene

Stock preparations of CAT-1 and CAT-2 of Preparation 1 are tested. Sixteen replicate aliquots of the stock preparation of CAT-1 or CAT-2 (see below) of Preparation 1 are used to prepare another sixteen diluted preparations of CAT-1 or CAT-2. Polymerization reactions are run in a manner similar to the procedure of Example 1 using 1-octene, either in neat form or as a solution in isopar, and excess molar equivalents of TEA. Maximum temperature exotherms (i.e., temperature increases) from room temperature were measured by subtracting room temperature value from maximum temperatures reached. Results are shown below in Table 1.

TABLE 1
Catalyst screening

| | | | | Octene/ | Average |
|---|---|---|---|---|---|
| Experiment | | mMol of | TEA mole | Isopar | Exotherm |
| Number | Catalyst | Catalyst | equivalents | (mL/mL) | (° C.) |
| 1 | CAT-1 | 2 | 50 | 5/0 | 8.2 |
| 2 | CAT-2 | 2 | 50 | 5/0 | 55.6 |
| 3 | CAT-1 | 2 | 50 | 10/0 | 8.3 |
| 4 | CAT-2 | 2 | 50 | 10/0 | 52.6 |
| 5 | CAT-1 | 4 | 50 | 5/5 | 7.3 |
| 6 | CAT-2 | 4 | 50 | 5/5 | 33.7 |
| 7 | CAT-1 | 4 | 50 | 5/5 | 7.2 |
| 8 | CAT-1 | 4 | 62.5* | 5/5 | 7.4 |
| 9 | CAT-1 | 5 | 50 | 5/5 | 8.3 |
| 10 | CAT-1 | 5 | 75 | 5/5 | 8.0 |
| 11 | CAT-1 | 6 | 42* | 5/5 | 9.0 |
| 12 | CAT-1 | 6 | 50 | 5/5 | 11.2 |
| 13 | CAT-1 | 5 | 100 | 5/5 | 8.0 |
| 14 | CAT-1 | 5 | 200 | 5/5 | 7.6 |
| 15 | CAT-1 | 6 | 100 | 5/5 | 9.6 |
| 16 | CAT-1 | 6 | 200 | 5/5 | 8.8 |

*Source of TEA for Experiment Numbers 8 and 11 were switched, changing the target loading

As shown by comparing average exotherm data in Table 1 from experiments 1 and 2; 3 and 4; and 5 and 6, the exotherm temperature increase with CAT-1 is smaller than exotherm temperature increase with CAT-2, indicating that CAT-2 is better at catalyzing polymerization of 1-octene and other olefins than is CAT-1.

The effects of varying catalyst concentration on maximum exotherm temperature reached using 50 mole equivalents of TEA is graphically illustrated in FIG. 6. In FIG. 6, increasing CAT-1 catalyst concentration resulted in a non-linear increase in maximum exotherm temperature reached.

The effects of varying TEA mole equivalents (compared to titanium) on maximum exotherm temperature reached using 5 mMol of CAT-1 catalyst are graphically illustrated in FIG. 7. In FIG. 7, increasing TEA mole equivalents resulted in a linear decrease in maximum exotherm temperature reached.

Results from Example 2 demonstrate that an invention apparatus of the first embodiment and an invention method of the second embodiment may be employed to rapidly test and compare different catalyst formulations for superior catalytic activity.

In the experiments of Examples 1 and 2, from about 3.3° C. to about 4.2° C. portions of the temperature increases are believed to be due to exotherms resulting from heat generated by a stirrer assembly of the invention apparatus and not from polymerization exotherms.

In a manner similar to the methods described above in Examples 1 and 2, two different homogeneous alpha olefin polymerization catalysts HC-1 and HC-2 are used in place of CAT-1 and CAT-2. The alpha olefin 1-octene is polymerized using HC-1 and HC-2 and the exotherm temperature increases are measured and compared to evaluate efficiencies of HC-1 and HC-2 homogeneous catalysts.

Examples of objects, materials, characteristics, and features are listed herein for illustration purposes and are non-limiting. A non-listed conventional object, material, characteristic, or feature may be substituted for a listed one.

Example(s) of the invention and Preparation(s), if any, described herein are for illustration purposes. Using methods analogous to those described therein, it is possible to prepare or conduct any embodiment of the invention without undue experimentation.

All invention elements and limitations comprising any embodiment of the invention are independently selected unless otherwise specified. All journal articles, text books, patents, published patent applications, and unpublished patent applications referenced herein are hereby incorporated by reference in their entireties for any and all purposes.

Illustrative embodiments of the invention are described herein. One of ordinary skill in the art (artisan) would know that supportable changes and modifications may be made to these embodiments without departing from the metes and bounds of the invention as described or claimed herein. Such supportable changes and modifications include substituting the phrase “consisting essentially of” or the phrase “consisting of” for any or all occurrences of the term “comprising” used in the description.

The invention is hereupon claimed.

What is claimed is:

1. An apparatus comprising:
(a) a plurality of sealed reactors, each sealed reactor independently comprising one or more aperture seals and a reactor body, each reactor body having an exterior surface and an interior surface, the exterior surface being spaced apart from, and generally parallel to, the interior surface so as to define the reactor body, each reactor body defining one or more sealable apertures between the exterior surface and the interior surface of the reactor body, each sealable aperture being in sealing operative contact with at least one of the aperture seals, each sealed reactor having disposed therein an enclosed volumetric space that functions as a sealed reactor chamber, and each exterior surface of the reactor body independently having a thermally-insulating effective area, wherein for each sealable aperture in the reactor body, at least one of the aperture seals prevents fluid communication between the exterior surface of the reactor body and the sealed reactor chamber via the sealable aperture, the sealed reactor chamber of each sealed reactor is in fluid communication with at least a portion of the interior surface of the reactor body of the sealed reactor, and the sealed reactor chambers of the sealed reactors are not in fluid communication with one another and are spaced apart from each other;
(b) one or more adiabatic thermal insulation means, wherein the thermally-insulating effective area of the exterior surface of each reactor body independently is in thermally-insulating operative contact with at least one of the one or more adiabatic thermal insulation means;
(c) a plurality of physico-chemical sensors, wherein each physico-chemical sensor is in sensing communication with a different one of the sealed reactor chambers; and
(d) at least one data device, wherein each data device is in data communication with one or more of the physico-chemical sensors and each physico-chemical sensor is in data communication with at least one data device.

2. The apparatus according to claim 1, wherein at least one aperture seal of each sealed reactor defines a reclosable aperture.

3. The apparatus according to claim 1, wherein each physico-chemical sensor is a temperature sensor.

4. The apparatus according to claim 3, wherein at least one aperture seal of each sealed reactor defines at least a probe aperture and each temperature sensor comprises a thermoelectrical temperature probe, wherein each thermoelectrical temperature probe crosses through the probe aperture of the at least one aperture seal of a different sealed reactor.

5. The apparatus according to claim 4, wherein each thermoelectrical temperature probe independently is a thermocouple, a resistance temperature detector, or a thermistor.

6. The apparatus according to claim 4, wherein each thermoelectrical temperature probe comprises a temperature sensing part that is not in direct physical contact with a reactor body of a sealed reactor.

7. The apparatus according to claim 1, the apparatus further comprising a means for mixing, the means for mixing being in operative contact with the sealed reactor chambers.

8. A method comprising the steps of:
(a) adding at least a first reactant and a second reactant to each of at least two of the sealed reactor chambers of the apparatus according to claim 1 so that the first and second reactants in each one of the at least two sealed reactor chambers are in operative contact with each other and comprise a reaction mixture that is sealed against fluid communication with a reaction mixture in any other of the at least two sealed reactor chambers and each one of the reaction mixtures is in sensing communication with a different one of the physico-chemical sensors, wherein the first reactants may be the same or different and the second reactants may be the same or different; and
(b) obtaining physico-chemical data for at least those reaction mixtures that form a reaction product.

9. The method according to claim 8, the method further comprising the step of comparing physico-chemical data of one of the reaction mixtures to physico-chemical data of another of the reaction mixtures, wherein the physico-chemical data for each of the reaction mixtures is generated essentially simultaneously.

10. The method according to claim 8, wherein the physico-chemical data are reaction temperature data.
